(19) United States
(12) Patent Application Publication
(10) Pub. No.: US 2025/0247673 A1
(43) Pub. Date: Jul. 31, 2025

(54) PROXIMITY DETERMINATION OF A DEVICE BY A READER

(71) Applicant: Samsung Electronics Co., Ltd., Suwon-si (KR)

(72) Inventor: Jeongho Jeon, San Jose, CA (US)

(21) Appl. No.: 19/023,016

(22) Filed: Jan. 15, 2025

Related U.S. Application Data
(60) Provisional application No. 63/626,881, filed on Jan. 30, 2024.
(60) Provisional application No. 63/677,723, filed on Jul. 31, 2024.

(51) Int. Cl. H04W 4/029

(52) U.S. Cl. CPC H04W 4/029

(57) ABSTRACT

Apparatuses and methods for proximity determination of a device by a reader. A method includes determining parameters related to transmission of a physical reader-to-device channel (PRDCH), determining parameters related to transmission of a physical device-to-reader channel (PDRCH) by the target device and transmitting the PRDCH. The PRDCH includes at least one of information related to the target device providing a device identifier corresponding to the target device, a device-group identifier corresponding to a group of target devices including the target device, or no identifier corresponding to all devices receiving the PRDCH, and the parameters related to the PDRCH transmission. The method further includes receiving the PDRCH from the target device or, from a second reader, a proximity determination report associated with the target device and determining the proximity of the target device based on reception of the PDRCH or reception of the proximity determination report.

### CROSS-REFERENCE TO RELATED AND CLAIM OF PRIORITY

The present application claims priority under 35 U.S.C. § 119(e) to U.S. Provisional Patent Application No. 63/626,881 filed on Jan. 30, 2024 and U.S. Provisional Patent Application No. 63/677,723 filed on Jul. 31, 2024, which are hereby incorporated by reference in their entirety.

### TECHNICAL FIELD

The present disclosure relates generally to wireless communication systems and, more specifically, the present disclosure is related to apparatuses and methods for proximity determination of a device by a reader.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to proximity determination of a device by a reader.

In one embodiment, a method for a first reader to determine a proximity of a target device is provided. The method includes determining parameters related to transmission of a physical reader-to-device channel (PRDCH), determining parameters related to transmission of a physical device-to-reader channel (PDRCH) by the target device, and transmitting the PRDCH. The PRDCH includes at least one of information related to the target device providing a device identifier corresponding to the target device, a device-group identifier corresponding to a group of target devices including the target device, or no identifier corresponding to all devices receiving the PRDCH, and the parameters related to the PDRCH transmission. The method further includes receiving the PDRCH from the target device or, from a second reader, a proximity determination report associated with the target device and determining the proximity of the target device based on reception of the PDRCH or reception of the proximity determination report.

In another embodiment, a first reader is provided. The first reader includes a processor configured to determine parameters related to transmission of a PRDCH and determine parameters related to transmission of a PDRCH by the target device. The first reader further includes a transceiver operably coupled to the processor. The transceiver is configured to transmit the PRDCH and receive the PDRCH from a target device or, from a second reader, a proximity determination report associated with the target device. The PRDCH includes at least one of information related to the target device providing a device identifier corresponding to the target device, a device-group identifier corresponding to a group of target devices including the target device, or no identifier corresponding to all devices receiving the PRDCH and the parameters related to the PDRCH transmission. The processor is further determine a proximity of the target device based on reception of the PDRCH or reception of the proximity determination report.

In yet another embodiment, an internet of things (IoT) device is provided. The IoT device includes a transceiver configured to receive, from a first reader, a PRDCH. The PRDCH includes at least one of information related to the IoT device providing a device identifier corresponding to the IoT device, a device-group identifier corresponding to a group of devices including the IoT device, or no identifier corresponding to all devices receiving the PRDCH and parameters related to transmission of a PDRCH by the IoT device. The transceiver is further configured to transmit the PDRCH to the first reader or a second reader. A proximity of the IoT device is identified based on the transmission of the PDRCH.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a diagram of an example type-1 backscatter structure for internet of thing(s) (IoT) devices according to embodiments of the present disclosure;

FIG. 10 illustrates a diagram of an example impedance matching circuit according to embodiments of the present disclosure;

FIG. 11 illustrates a diagram of an example type-2 backscatter structure for IoT devices according to embodiments of the present disclosure;

FIG. 12 illustrates a diagram of an example type-2 active backscatter structure for IoT devices according to embodiments of the present disclosure;

FIG. 13 illustrates a diagram of an example type-2 active backscatter structure for IoT devices according to embodiments of the present disclosure;

FIG. 14 illustrates a timeline for single-sided two way ranging (SS-TWR) according to embodiments of the present disclosure;

FIG. 15 illustrates a flowchart of an example procedure for ranging according to embodiments of the present disclosure;

FIG. 16 illustrates a flowchart of an example procedure for ranging according to embodiments of the present disclosure;

FIG. 17 illustrates a timeline for SS-TWR according to embodiments of the present disclosure;

FIG. 18 illustrates an example system for transmission according to embodiments of the present disclosure;

FIG. 19 illustrates an example system for ranging operation according to embodiments of the present disclosure;

FIG. 20 illustrates a timeline for double-sided two way ranging (DS-TWR) according to embodiments of the present disclosure;

FIG. 21 illustrates a timeline for multi-round DS-TWR according to embodiments of the present disclosure;

FIG. 22 illustrates a diagram of an example type-1 backscatter structure for IoT devices according to embodiments of the present disclosure;

FIG. 23 illustrates a diagram of an example type-2a backscatter structure for IoT devices according to embodiments of the present disclosure;

FIG. 24 illustrates a diagram of an example type-2a backscatter structure for IoT devices according to embodiments of the present disclosure;

FIG. 25 illustrates a diagram of an example type-2a backscatter structure for IoT devices according to embodiments of the present disclosure;

FIG. 26 illustrates a diagram of an example type-2b backscatter structure for IoT devices according to embodiments of the present disclosure;

FIG. 27 illustrates a diagram of an example type-2b backscatter structure for IoT devices according to embodiments of the present disclosure;

FIG. 28 illustrates a diagram of an example type-2b backscatter structure for IoT devices according to embodiments of the present disclosure;

FIG. 29 illustrates an example system for D2R/R2D transmission including an intermediate node according to embodiments of the present disclosure;

FIG. 30 illustrates example signal structures according to embodiments of the present disclosure;

FIG. 31 illustrates a flowchart of an example procedure for proximity determination according to embodiments of the present disclosure;

FIG. 32 illustrates a timeline for immediate reflection according to embodiments of the present disclosure;

FIG. 33 illustrates an example system for signal transmission and reception according to embodiments of the present disclosure;

FIG. 34 illustrates an example system for proximity determination according to embodiments of the present disclosure;

FIG. 35 illustrates a flowchart of an example procedure for proximity determination according to embodiments of the present disclosure;

FIG. 36 illustrates a flowchart of an example procedure for proximity determination according to embodiments of the present disclosure;

FIG. 37 illustrates an example system for proximity determination according to embodiments of the present disclosure;

FIG. 38 illustrates a flowchart of an example procedure for proximity determination according to embodiments of the present disclosure; and

FIG. 39 illustrates a flowchart of an example procedure for proximity determination according to embodiments of the present disclosure.

### DETAILED DESCRIPTION

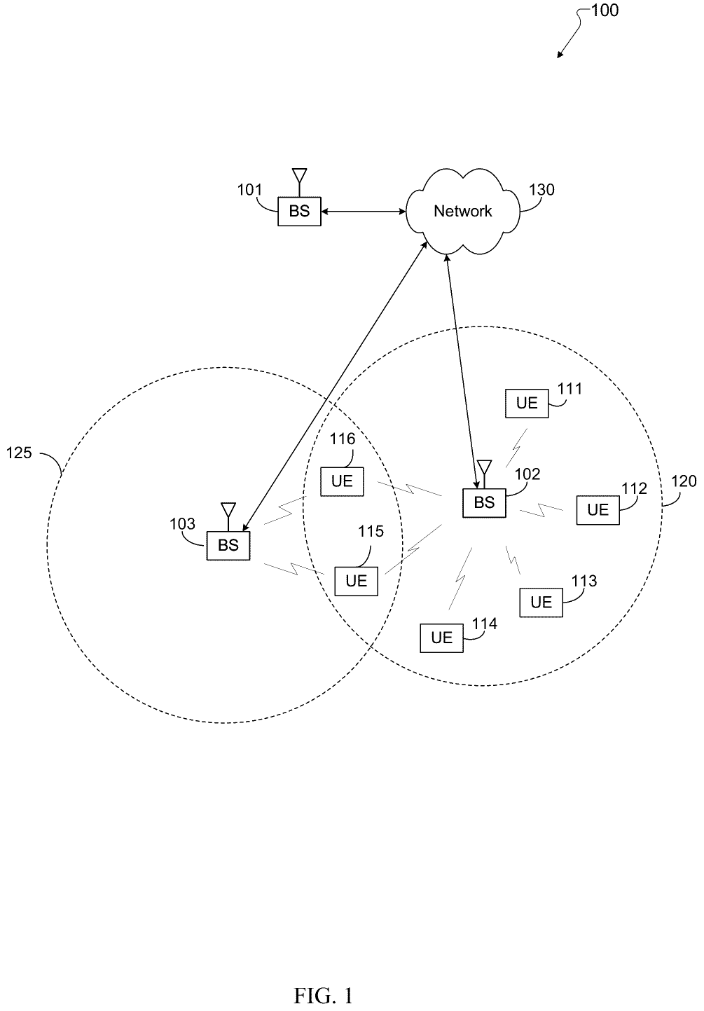

FIGS. 1-39, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 v18.3.0, “NR; Physical channels and modulation;” [REF 2] 3GPP TS 38.212 v18.3.0, “NR; Multiplexing and channel coding;” [REF 3] 3GPP TS 38.213 v18.3.0, “NR; Physical layer procedures for control;” [REF 4] 3GPP TS 38.214 v18.3.0, “NR; Physical layer procedures for data;” [REF 5] 3GPP TS 38.331 v18.1.0, “NR; Radio Resource Control (RRC) protocol specification;” and [REF 6] 3GPP TS 38.321 v18.1.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting a proximity determination of a device by a reader. In certain embodiments, one or more of the gNBs 101-103 include circuitry, programing, or a combination thereof to provide for proximity determination of a device by a reader.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

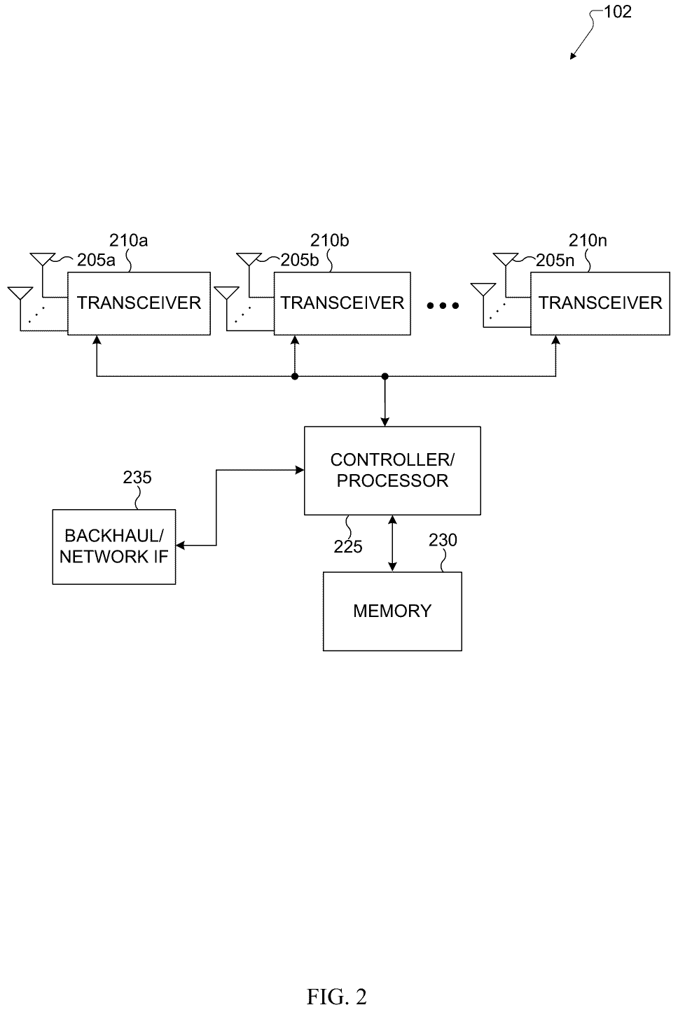

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for proximity determination of a device by a reader. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

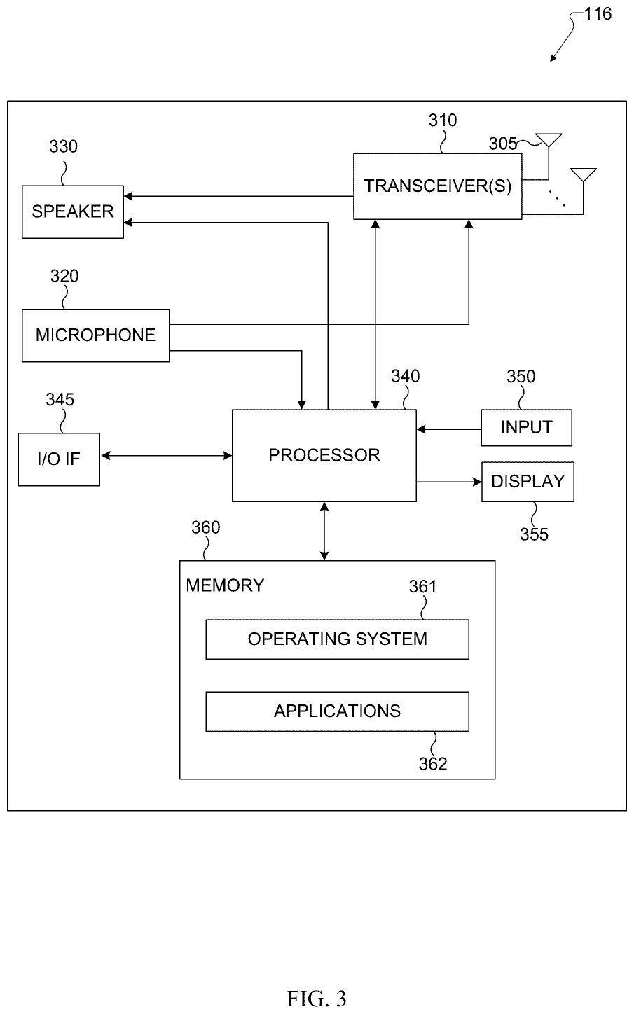

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support proximity determination of a device by a reader as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

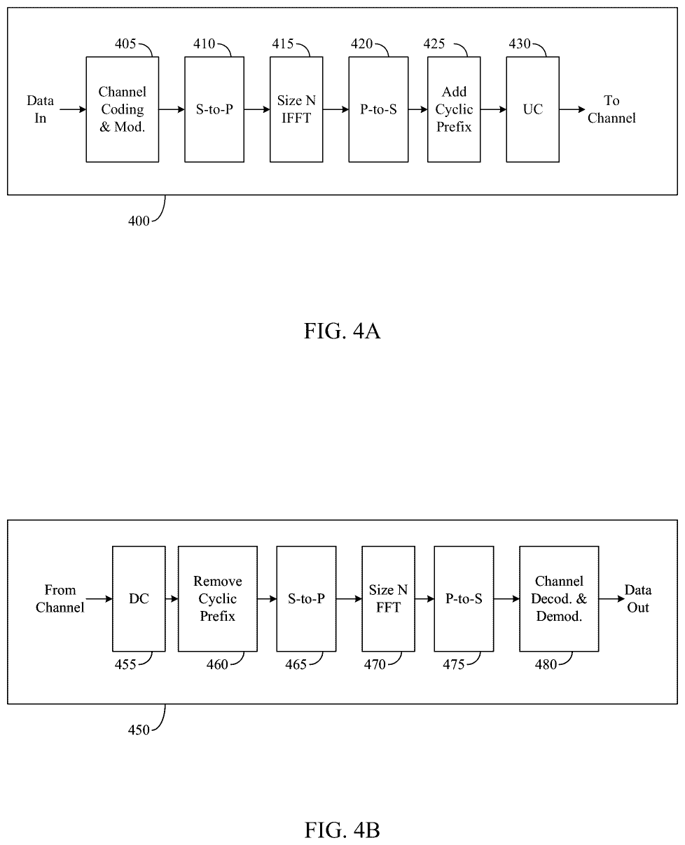

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform or utilize proximity determination of a device by a reader as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., operating as a reader), or may indirectly communicate with a reader through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT UE is same as the receiving node from the A-IoT UE, or can be bi-static (or multi-static) wherein the transmitter nodes to the A-IoT UE can be different from the receiving nodes from the A-IoT UE.

In various embodiments, the A-IoT device operates with energy storage and power management capability. These devices are characterized by ultra-low power consumption and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned CW signal.

The disclosure relates to defining functionalities and procedures for A-IoT devices to perform proximity determination of a device by a reader. DL and UL are also referred to as reader-to-device (R2D) and device-to-reader (D2R), respectively, and vice versa.

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

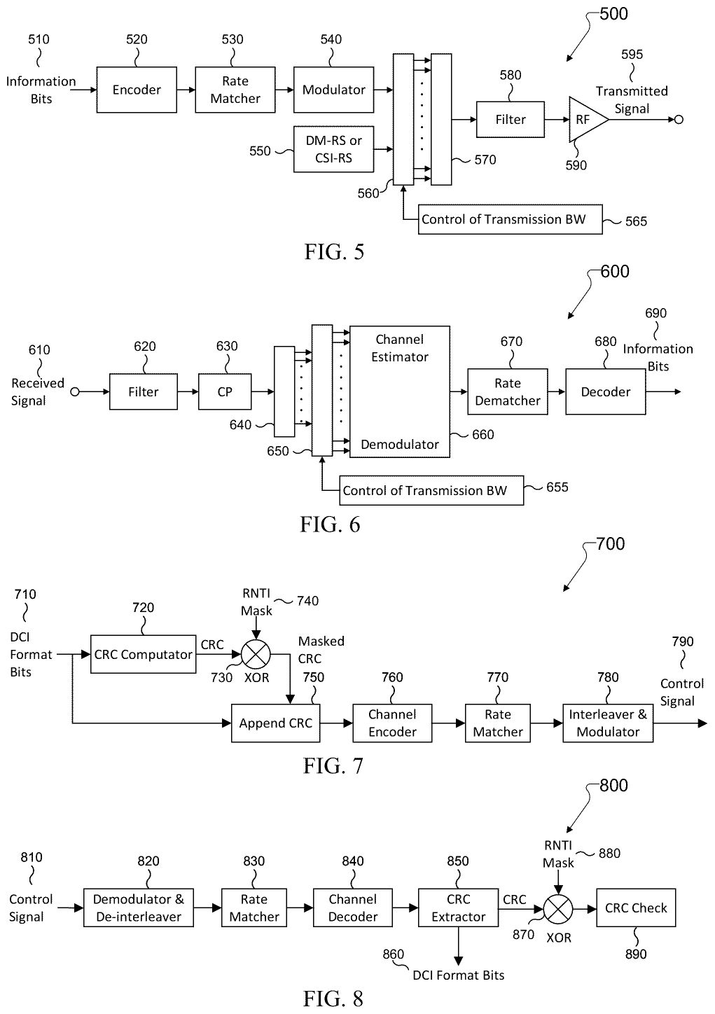

FIG. 6 illustrates an example of a receiver structure 600 using OFDM according to embodiments of the present disclosure. For example, receiver structure 600 using OFDM can be implemented by any of the Us 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB, the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
   Indoor sensor
Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Considering the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

R2D (e.g., PRDCH) transmissions can be based on an OFDM waveform including a variant using DFT precoding that is known as DFT-spread-OFDM.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v17.6.0, “NR; Physical channels and modulation”, and 3GPP TS 38.213 v17.6.0 “NR; Physical Layer procedures for control”.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 v17.6.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 v17.6.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 v17.6.0, so that the DCI size limit would not be exceeded.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 v17.6.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the mentioned herein limits/maximum per slot for scheduling on the primary cell, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 v17.6.0.

For same cell scheduling or for cross-carrier scheduling where a scheduling cell and scheduled cells have DL BWPs with same SCS configuration μ, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE (e.g., the UE 116) receives PDCCH/PDSCH from a corresponding TRP as described in TS 38.213 v17.6.0 and TS 38.214 v17.6.0.

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

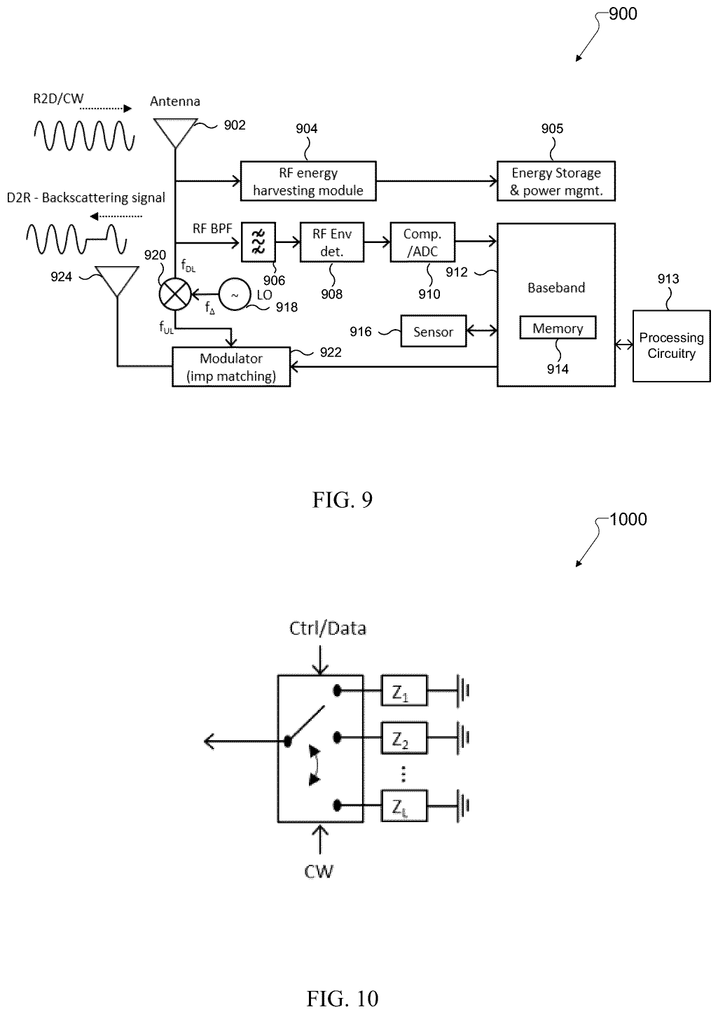

FIG. 9 illustrates a diagram of example type-1 backscatter structure 900 for IoT devices according to embodiments of the present disclosure. For example, the type-1 backscatter structure 900 can be implemented by a UE, such as UE 116 of FIG. 3, or may be devices with fewer components and functionality than a UE. This example is for illustration only and other embodiments can be used without departing from the scope of the present disclosure.

As shown in FIG. 9, the type-1 backscatter structure 900 for IoT device includes an antenna 902, a RF energy harvesting module 904, an energy storage and power management 905, a RF bandpass filter (BPF) 906, a RF envelope detector 908, a comparator/analog to digital converter (ADC) 910, a baseband 912, processing circuitry 913, a memory 914, a sensor 916, a local oscillator (LO) 918, a mixer 920, a modulator (impedance matching) 922, and an antenna 924.

Several different types of A-IoT devices can be considered. One device type has ˜1 μW peak power consumption, energy storage, initial sampling frequency offset (SFO) up to 10^{X} ppm, neither R2D nor D2R amplification in the device, wherein the device's D2R transmission is backscattered on a carrier wave (CW) provided externally. This type of device is referred to as Type-1 backscatter device, or Type-1 device in short, in this disclosure. Another type of device has ≤ a few hundred μW peak power consumption, energy storage, initial sampling frequency offset (SFO) up to 10^{X} ppm, both R2D and/or D2R amplification in the device, wherein the device's D2R transmission may be generated internally by the device, or be backscattered on a CW provided externally, which are referred to as Type-2 active device and Type-2 backscatter device, respectively.

With reference to FIG. 9, an example Type-1 backscatter device structure is shown.

The CW is externally provided from a reader or a dedicated source. The CW can be used for RF energy harvesting, e.g., using rectifier, and the harvested energy can be stored in an energy storage, which can be a capacitor, super-capacitor, or generally termed as a rechargeable battery. The R2D signal is demodulated using low complexity envelop detector and comparator, whose output is provided as an input to the baseband circuit. Different demodulation techniques other than envelop detector can be used as well. The D2R signal transmission is via backscattering of the externally provided CW. FIG. 9 is illustrated for an frequency division duplexing (FDD) system involving a frequency shifter, if the CW is provided in a frequency different than the D2R carrier frequency. Considering that the A-IoT devices are targeting for low complexity and low power consumption, the following options can be considered as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the D2R carrier frequency; In this case, no frequency shifter is needed.
Use of harmonic frequencies of CW signal or intermodulation frequencies of two-tone CW signals.

Depending on the frequency shift options, the Type-1 backscatter device illustrated in FIG. 9 may not be equipped with an actual LO and frequency mixer, for instance when the CW signal is provided directly at the D2R carrier frequency. Type-1 backscatter can also operate in a time division duplexing (TDD) spectrum. In this case, the device does not require a frequency shifter to obtain a desired frequency shifting.

FIG. 10 illustrates a diagram of an example impedance matching circuit 1000 according to embodiments of the present disclosure. For example, impedance matching circuit 1000 can be implemented in the modulator (impedance matching) 922 of an IoT device. This example is for illustration only and other embodiments can be used without departing from the scope of the present disclosure.

With reference to FIG. 10, an example impedance matching circuit for backscatter device D2R modulation is shown.

The followings are examples of impedance matching operations:
Open circuit: Full reflection of the received CW signal in the same phase. This can be used for on-off keying (OOK) modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

The UE may indicate its modulation capability or impedance matching capability to the network (e.g., the network 130), or certain requirement may be predefined in the specification of system operation.

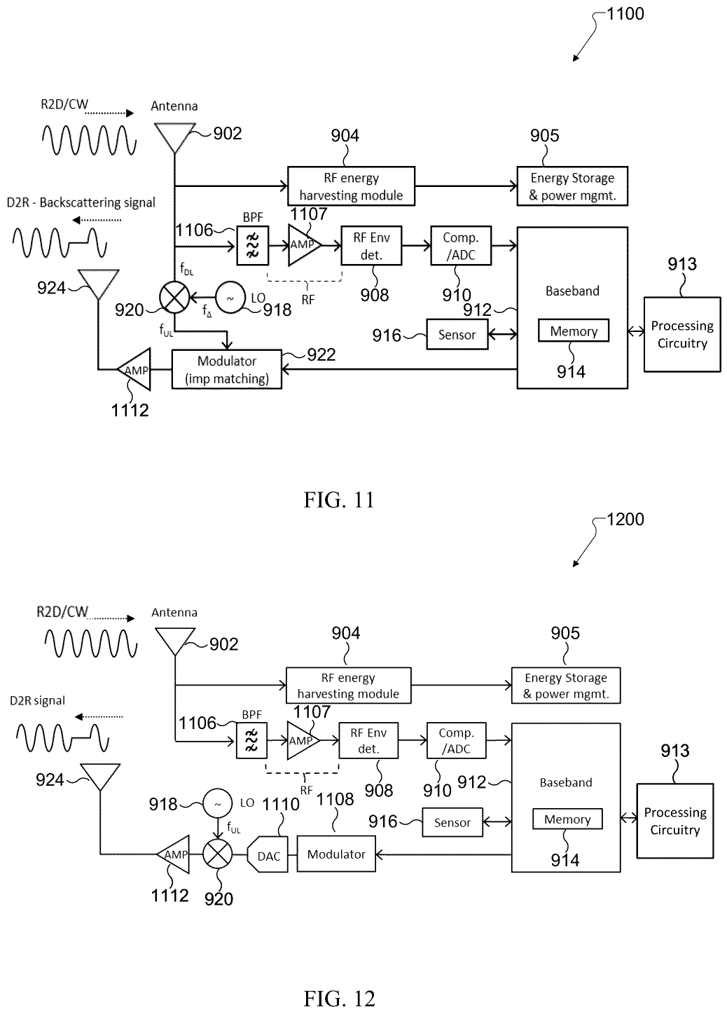

FIG. 11 illustrates a diagram of an example type-2 backscatter structure 1100 for IoT devices according to embodiments of the present disclosure. For example, type-2 backscatter structure 1100 can be implemented by a UE, such as UE 111 of FIG. 1, or may be devices with fewer components and functionality than a UE. This example is for illustration only and other embodiments can be used without departing from the scope of the present disclosure.

As shown in FIG. 11, the type-2 backscatter structure 1100 for IoT devices includes an antenna 902, a RF energy harvesting module 904, an energy storage and power management 905, a BPF 1106, an amplifier 1107, a RF envelope detector 908, a comparator/ADC 910, a baseband 912, processing circuitry 913, a memory 914, a sensor 916, a LO 918, a mixer 920, a modulator (impedance matching) 922, an amplifier 1112, and an antenna 924.

FIG. 12 illustrates a diagram of an example type-2 active backscatter structure 1200 for IoT devices according to embodiments of the present disclosure. For example, type-2 active backscatter structure 1200 can be implemented by a UE, such as UE 112 of FIG. 1, or may be devices with fewer components and functionality than a UE. This example is for illustration only and other embodiments can be used without departing from the scope of the present disclosure.

As shown in FIG. 12, the type-2 active backscatter structure 1200 for IoT devices includes an antenna 902, a RF energy harvesting module 904, an energy storage and power management 905, a BPF 1106, an amplifier 1107, a RF envelope detector 908, a comparator/ADC 910, a baseband 912, processing circuitry 913, a memory 914, a sensor 916, a LO 918, a mixer 920, a modulator 1108, an amplifier 1112, and an antenna 924.

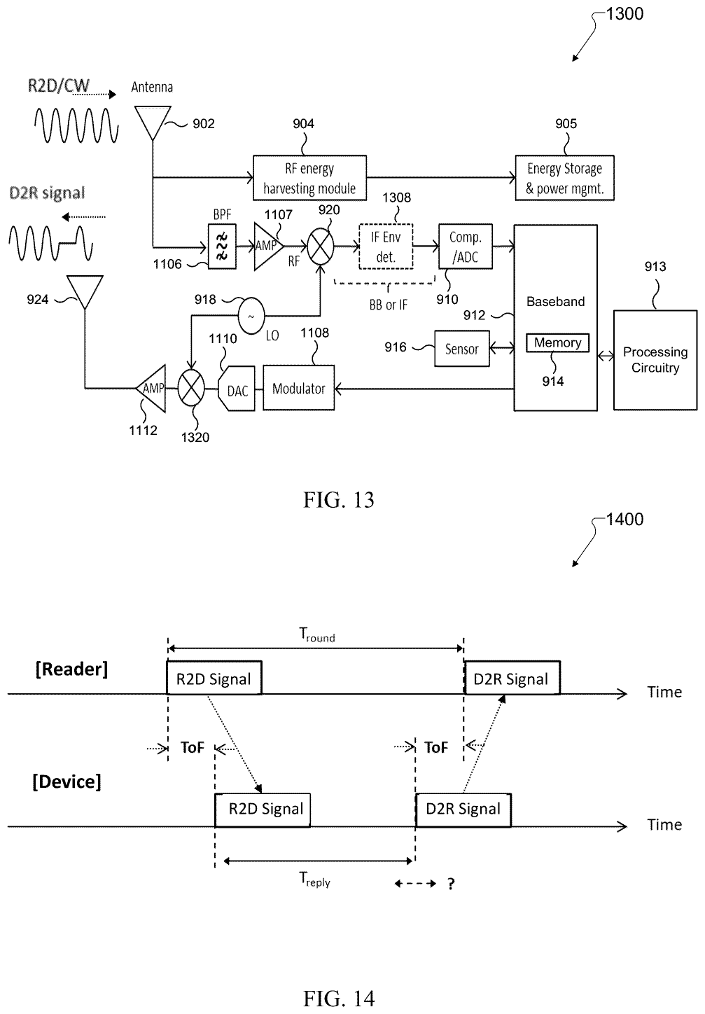

FIG. 13 illustrates a diagram of an example type-2 active backscatter structure 1300 for IoT devices according to embodiments of the present disclosure. For example, type-2 active backscatter structure 1300 can be implemented by a UE, such as UE 113 of FIG. 1, or may be devices with fewer components and functionality than a UE. This example is for illustration only and other embodiments can be used without departing from the scope of the present disclosure.

As shown in FIG. 13, the type-2 active backscatter structure 1300 for IoT devices includes an antenna 902, a RF energy harvesting module 904, an energy storage and power management 905, a BPF 1106, an amplifier 1107, a mixer 920, an intermediate frequency (IF) envelope detector 1308, a comparator/ADC 910, a baseband 912, processing circuitry 913, a memory 914, a sensor 916, a LO 918, a mixer 1320, a modulator 1108, a digital to analog (DAC) converter, an amplifier 1112, and an antenna 924.

With reference to FIG. 11 an example Type-2 backscatter device structure is shown.

Type-2 backscatter device may share similar structure at large with Type-1 backscatter device as the D2R transmission is based on backscattering of externally provided CW in both device types, while Type-2 backscatter device may be additionally equipped with active components for amplifying R2D received signal and D2R transmission signal. In one example, the amplifier architectures for R2D reception and D2R transmission can be based on common power amplifier (PA) and low noise amplifier (LNA) architecture using metal-oxide-semiconductor field-effect transistor (MOSFET). In another example, it can be a low-power and low-complexity architecture based on the operating principle similar to the one port negative resistance oscillator, which uses a single bipolar transistor terminated with microstrips.

With reference to FIG. 12, an example Type-2 active device structure with RF envelop detection according to the disclosure is shown.

Type-2 active device may share similar structure at large with Type-2 backscatter device including PA and LNA, while the Type-2 active device generates D2R signal internally using LO rather than externally provided CW. As an example, D2R signal can be modulated at the baseband, converted to an analog signal using digital to analog converter (DAC), which is then up-converted using LO and frequency mixer. The CW can be provided and utilized by Type-2 active device for RF energy harvesting. In FIG. 12, the R2D demodulation is still assumed to be based on the low complexity envelop detector and comparator. In another architecture, the R2D demodulation may be also connected to LO and mixer for frequency down-conversion, analog to digital converter (ADC), and followed by baseband symbol detection block.

In FIG. 12, the R2D demodulation is still assumed to be based on the low complexity RF envelop detector followed by 1-bit comparator or ADC, in general. Other options are as follows such as heterodyne architecture with IF envelope detection or homodyne architecture with baseband detection, given that LO is already assumed for D2R transmission in this Type-2 active device.

With reference to FIG. 13, an example Type-2 active device structure with IF envelop detection or BB detection according to the disclosure is shown.

In the heterodyne architecture with IF envelope detection, the RF signal is down converted into IF signal via an RF mixer with a LO. The IF signal is then converted into baseband signal via an IF envelope detection. In the homodyne/zero-IF architecture, the RF signal is directly down converted into baseband signal via an RF mixer with a LO.

FIGS. 9-13 should be understood for illustration purpose only. There can be other components not explicitly shown in the figure such as switch, duplexer, and filters, or some components may be replaced to different options. Also, the devices can operate both in TDD and FDD spectrum and, depending on the operating spectrum, the actual architectures can be different from the conceptual illustrations in the figures.

In deploying A-IoT devices, different topology options can be considered. The following provides examples of topology options:
Topology 1: BS↔ A-IoT device
   An A-IoT device directly and bidirectionally communicates with a basestation. The communication between the basestation and the A-IoT device includes A-IoT data and/or signalling. This topology includes the possibility that the BS transmitting to the A-IoT device is a different from the BS receiving from the A-IoT device.
Topology 2: BS↔intermediate node↔Ambient IoT device
   An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node or reader device in this disclosure.
Topology 3: BS↔assisting node↔Ambient IoT device↔BS
   An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE (e.g., the UE 116) and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be assumed that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

Any operations performed by BS in this disclosure can be also performed by I-node instead of the BS, and each or part of interfaces are transparent to the A-IoT devices.

This disclosure relates to proximity determination of A-IoT devices. In general, positioning is to determine a 2D coordinate of a device, which requires at least two or more TRPs, while ranging is to determine a distance to the device, i.e., proximity determination, which can be performed with single TRP.

FIG. 14 illustrates a timeline 1400 for SS-TWR according to embodiments of the present disclosure. For example, timeline 1400 can be followed by any of the IoT devices described herein and a reader such as gNB/intermediate UE (I-UE), e.g., the BS 102 of FIG. 1. This example is for illustration only and other embodiments can be used without departing from the scope of the present disclosure.

With reference to FIG. 14, an example SS-TWR for proximity determination using ToF based on round-trip time (RTT) measurement according to the disclosure is shown. The ToF is calculated by ToF=½*(T_{round}−T_{reply}) from which the distance can be calculated by multiplying the speed of light. One challenge with the scheme herein is the susceptibility to the clock drift error, i.e., keeping the T_{reply} precisely, which requires accurate LO.

Given that A-IoT devices are expected to be equipped with low cost low-grade LO, the A-IoT devices may be lacking a precise timing maintenance capability, which is generally assumed for normal UEs.

Also, A-IoT devices' D2R transmission may be based on backscattering of externally provided CW or internally generated, which is expected for normal UEs, as illustrated in the figures herein.

Therefore, embodiments of the present disclosure recognize that there is a need to define procedures and methods for proximity determination of a device whose D2R transmission is based on backscattering of externally provided CW.

Embodiments of the present disclosure further recognize that there is another need to define procedures and methods for proximity determination of a device, which is lacking a precise timing maintenance capability.

The disclosure relates to a communication system. The disclosure relates to defining functionalities and procedures for determining a proximity to A-IoT devices whose D2R transmission is based on backscattering or based on internally generated signal but lacking a precise timing capability.

The disclosure relates to defining functionalities and procedures for proximity determination of a device whose D2R transmission is based on backscattering of externally provided CW.

The disclosure further relates to defining functionalities and procedures for proximity determination of a device whose D2R transmission is based on internal signal generation while the device is lacking a precise timing maintenance capability.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for determining a proximity to a device whose D2R transmission is based on backscattering or based on internally generated signal but lacking a precise timing capability are summarized in the following and are fully elaborated further herein.
Method and apparatus for defining functionalities and procedures for measuring ToF with a device whose D2R transmission is based on backscattering via a signature signal for the identification of transmission timing and immediate reflection by the backscattering device without delay.
Method and apparatus for defining functionalities and procedures for measuring ToF with a device whose D2R transmission is based on internally generated signal but lacking a precise timing capability by canceling the effect of clock drift by measuring the RTT twice, i.e., reader→device→reader, and device→reader→device.

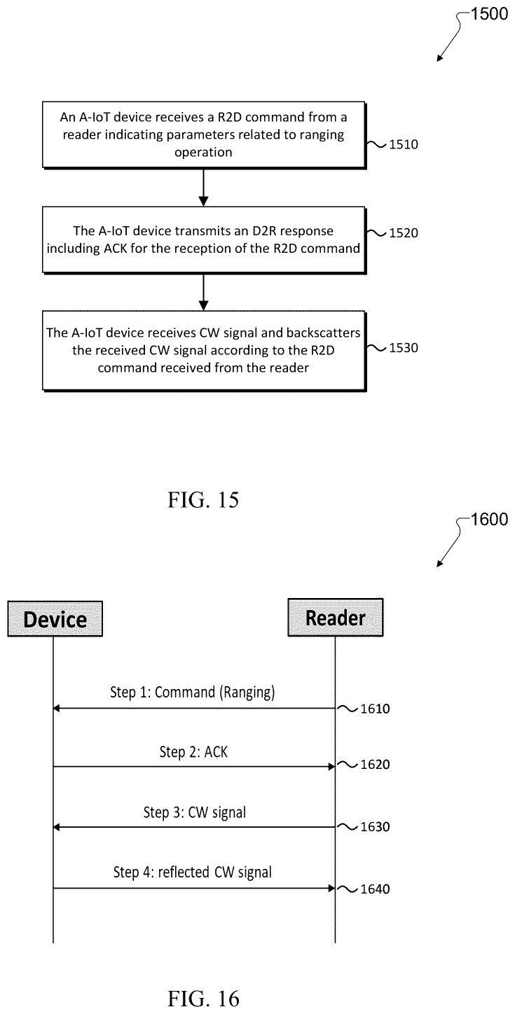

FIG. 15 illustrates a flowchart of an example procedure 1500 for ranging according to embodiments of the present disclosure. For example, procedure 1500 can be performed by any of the IoT devices described herein. This example is for illustration only and other embodiments can be used without departing from the scope of the present disclosure.

The procedure begins in 1510, an A-IoT device receives a R2D command from a reader indicating parameters related to ranging operation. In 1520, the A-IoT device transmits an D2R response including acknowledgement (ACK) for the reception of the R2D command. In 1530, the A-IoT device receives CW signal and backscatters the received CW signal according to the R2D command received from the reader.

FIG. 16 illustrates a flowchart of an example procedure 1600 for ranging according to embodiments of the present disclosure. For example, procedure 1600 can be performed by any of the IoT devices described herein and a reader, such as the BS 102 of FIG. 1. This example is for illustration only and other embodiments can be used without departing from the scope of the present disclosure.

The procedure begins in 1610, a reader transmits a command (ranging) to an A-IoT device. In 1620, the A-IoT device transmits an ACK to the reader. In 1630, the reader transmits a CW signal to the A-IoT device. In 1640, the A-IoT device transmits a reflected CW signal to the reader.

The general principle of proximity determination method for a backscatter device includes a R2D command from a reader indicating parameters related to ranging operation, and the reception and backscattering of the received CW signal by an A-IoT device.

With reference to FIG. 15, an example flowchart of a backscatter device to perform ranging is shown according to the disclosure.

With reference to FIG. 16, a signal flow for ranging between a BS and a backscatter device is shown according to the disclosure.

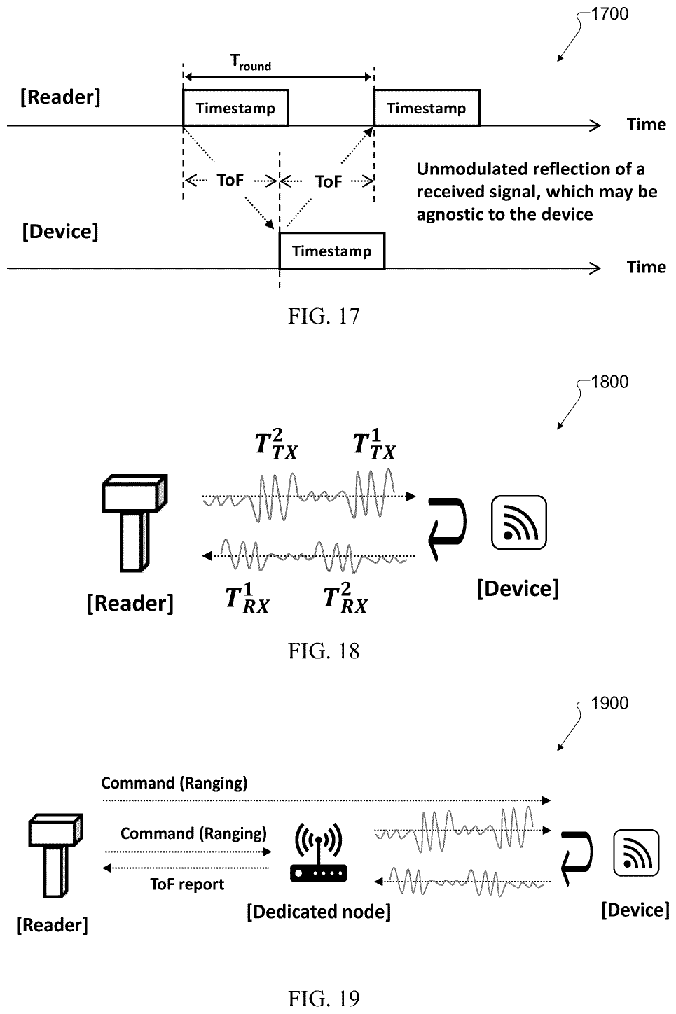

FIG. 17 illustrates a timeline 1700 for SS-TWR according to embodiments of the present disclosure. For example, timeline 1700 can be followed by any of the IoT devices described herein and a reader, such as the BS 103 of FIG. 1. This example is for illustration only and other embodiments can be used without departing from the scope of the present disclosure.

With reference to FIG. 17, an example SS-TWR involving a backscatter device is shown according to the disclosure. As illustrated in the figure, a device receives CW signal from a BS and backscatters the received signal immediately without a delay and, thereby, the inaccuracy involved with T_{reply} due to low-grade LO in FIG. 14 is removed. The CW signal can be in general any R2D signal received at the A-IoT device, i.e., it does not need to be a CW and the signal can be either modulated or unmodulated. The signal can be transmitted from a reader or a dedicated node for CW transmission.

An A-IoT device receives a R2D command from a reader indicating parameters related to ranging operation 1510. The R2D command signal may indicate the following parameters:
Signal type indicating that it is a command type R2D control signaling for initiating ranging operation.
An ID associated with the device that the reader triggers ranging operation.
A time duration for backscattering the received signal. The time duration can be indicated by an offset from the reception of the R2D command and a duration, wherein the offset and the duration can be indicated in terms of a certain time unit, e.g., second, millisecond, microsecond, a basic time unit, Tₛ, symbol, or slot, etc.
Backscattering transmission to be either unmodulated or modulated.
Power control parameter, such as full power backscattering, certain power reduction, or power boosting which may be only applicable for a device type equipped with D2R amplification. The indication can be provided in dB, or by an index from a set of predefined power reduction or boosting values.

Unmodulated backscattering transmission by the A-IoT device involves plain reflection of the received signal by the A-IoT device during the indicated time duration without alteration. When the device is indicated to perform modulated backscattering transmission, the reflection can be modulated with, e.g., a predefined sequence or a sequence associated with the device ID. The modulation sequence can be predefined in the specifications of the system operation or indicated to the device as a part of R2D command signaling. A predefined sequence may be comprised of 1s and 0s. In one simple example, the sequence can be a number of 1s, a number of 0s, a number of alternations between 1 and 0, or equivalently alternations between high (On) and low (Off) voltage states. With the modulated backscattering transmission, the reader can identify the transmitter of the D2R backscattering signal.

The A-IoT device transmits an D2R response including ACK for the reception of the R2D command 1520. This D2R transmission is performed via backscattering. This step may be omitted.

The A-IoT device receives CW signal and backscatters the received CW signal according to the R2D command received from the reader 1530. The CW signal transmitted by BS, I-UE, or a dedicated node may include a signature, e.g., a certain time pattern or sequence modulated on the CW, for the purpose of time stamping.

FIG. 18 illustrates an example system 1800 for transmission according to embodiments of the present disclosure. For example, system 1800 can be implemented in the wireless network of FIG. 1. This example is for illustration only and other embodiments can be used without departing from the scope of the present disclosure.

With reference to FIG. 18, an example R2D transmission including a timestamp signal is shown according to the disclosure. The CW signal may be modulated with a certain time pattern or sequence for recognizing the transmission time instance, i.e., timestamp. The CW signal may be indicated and known by the device, or it may be agnostic to the device.

With the timestamp, the reader calculates the ToF as ToF=T_{RX}¹−T_{TX}¹, where T_{TX}¹ and T_{RX}¹ are transmit and receive times of the timestamp signal. A time pattern may be repeated one or multiple times. In another example, the signal comprises of one or more than one distinct time patterns transmitted in series. In this case, the ToF can be averaged over multiple rounds of transmission and reception. For instance, if a signal is repeated N times, the ToF can be calculated as

$$ToF = \frac{1}{N} * {\sum }_{i = 1}^{N} {ToF}_{i} , where {ToF}_{i} = {T}_{RX}^{i} - {T}_{TX}^{i} ,$$

is the ToF of the i-th round.

The reader may also measure reference signal received power (RSRP), received signal strength indicator (RSSI), reference signal received quality (RSRQ), or signal-to-interference-plus-noise ratio (SINR) from the received D2R backscattering signal and utilize the measurement for proximity determination. The pathloss can be measured by the reader as PL=(Pₜₓ−Pᵣₓ+Attn)/2, wherein Pₜₓ is the R2D signal transmission power from a reader and Pᵣₓ is a received power of D2R backscattering signal at the reader. Attn is the total attenuation at the A-IoT device, which is measured as a difference between the received R2D signal and backscattered D2R signal at the device. The device may report the Attn value to the reader, which may be in dB, or using an index from a set of predefined values or range of values. Using the measured PL and a pathloss equation for the given environment, which is a function of a distance and the frequency, the reader can determine a proximity to the device.

FIG. 19 illustrates an example system 1900 for ranging operation according to embodiments of the present disclosure. For example, system 1900 can be implemented in the wireless network of FIG. 1. This example is for illustration only and other embodiments can be used without departing from the scope of the present disclosure.

With reference to FIG. 19, an example ranging operation involving an intermediate dedicated node is shown.

An A-IoT device receives a R2D command from a reader indicating parameters related to ranging operation, wherein the parameters may include signal type, an associated device ID, a time duration for backscattering the received signal, backscattering transmission to be either unmodulated or modulated, and power control parameter, as disclosed herein.

A R2D command from the reader to the dedicated node may include the following parameters:
Signal type indicating that it is a command type R2D control signaling for initiating ranging operation.
An ID of the dedicated node that the reader triggers ranging operation.
A time duration for CW signal transmission during which the dedicated node is expected to transmit the CW.
A transmission of a timestamp signal for measuring ToF, as disclosed herein, including a number of rounds, i.e., repetitions or distinct signals.
Report configuration for sending the measured ToF or PL to the reader.

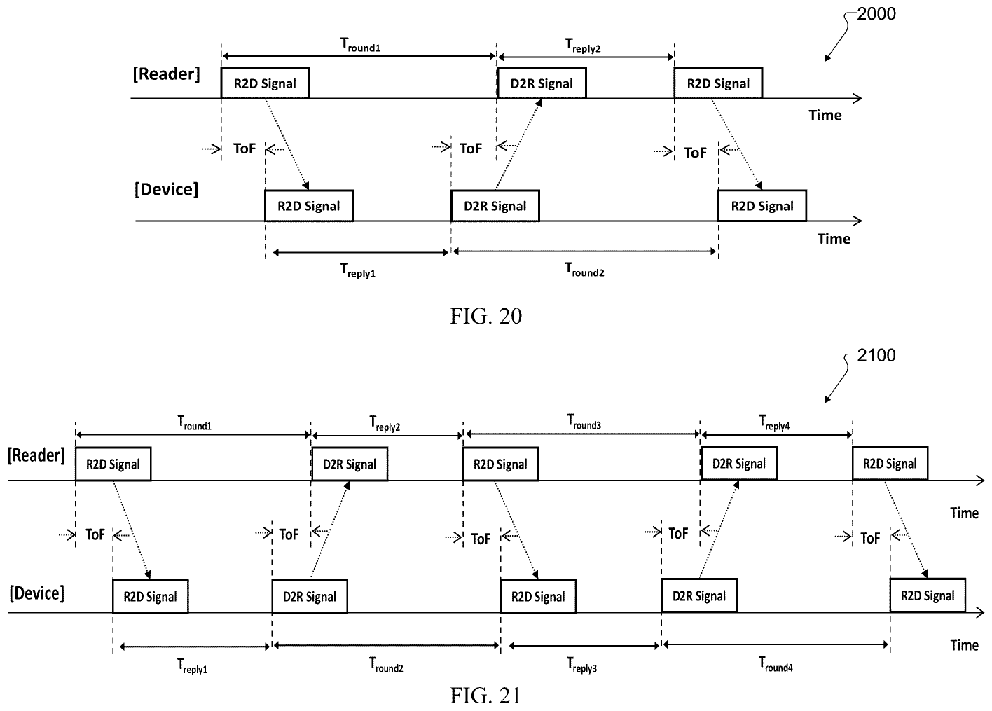

FIG. 20 illustrates a timeline 2000 for DS-TWR according to embodiments of the present disclosure. For example, timeline 2000 can be followed by any of the IoT devices described herein and a reader, such as the BS 102 of FIG. 1. This example is for illustration only and other embodiments can be used without departing from the scope of the present disclosure.

The general principle of proximity determination method for a D2R active device with inaccurate timing includes exchanges of multiple rounds of RTT measurement starting from a reader to a device and back to the reader, and the reverse, i.e., starting from a device to the reader and back to the device.

With reference to FIG. 20, an example DS-TWR operation is shown according to the disclosure.

The reader transmits R2D signal for initiating the ranging operation with a particular

A-IoT device, which may include the following parameters.
Signal type indicating that it is a command type R2D control signaling for initiating ranging operation.
An ID associated with the device that the reader triggers ranging operation.
A number of rounds for ToF measurement. One round may include transmission and reception of R2D and D2R signals as illustrated in the figure. The last transmission and reception of R2D signals can be also utilized for the next round of ToF measurement.
Remaining R2D signal counts, which indicates how many subsequent R2D signals that the device is expected to receive for the purpose of ranging.
Request for D2R signal transmission and parameters related to D2R transmission, e.g., D2R transmit power control parameters, signal type and transmission duration, and the resource configuration for D2R transmission, e.g., in time and frequency.
Expected D2R signal transmission timing, i.e., the reader indicates T_{reply} and the device responds after T_{reply} time from the reception of R2D signal to the transmission of D2R signal.

After receiving the R2D signal for ranging, the device transmits the D2R signal according to the indication provided by the reader, and the D2R signal may include the following parameters.
Signal type indicating that it is a D2R control signaling for responding as a part of ranging operation.
An ID associated with the device transmitting the D2R signal.
Timing information, e.g., timestamp when the R2D signal is received, timestamp when the D2R transmission is transmitted, or reply time, T_{reply} from the reception of R2D signal to the transmission of D2R signal.

After transmitting the D2R signal, the device receives R2D signal once again, as illustrated in FIG. 20. The device may be provided from the reader the expected time span to receive the following R2D signal for scanning, which can be provided by an offset from a certain timing, e.g., D2R transmission timing or a certain timing index, and a duration for monitoring. After receiving the second R2D signal, the device measures the T_{round} time, which is measured from the transmission of D2R signal to the reception of R2D signal.

In the subsequent operation, the device reports to the reader, the T_{round} time, timestamp when the D2R transmission is transmitted, or timestamp when the R2D signal is received. Based on reported values, the reader can calculate the ToF as

$$ToF = \frac{( {T}_{round 1} * {T}_{round 2} - {T}_{reply 1} * {T}_{reply 2} )}{( {T}_{round 1} + {T}_{round 2} + {T}_{reply 1} + {T}_{reply 2} )} .$$

FIG. 21 illustrates a timeline 2100 for multi-round DS-TWR according to embodiments of the present disclosure. For example, timeline 2100 can be followed by any of the IoT devices described herein and a reader, such as the BS 103 of FIG. 1. This example is for illustration only and other embodiments can be used without departing from the scope of the present disclosure.

With reference to FIG. 21, an example multi-round DS-TWR operation according to the disclosure is shown.

The general principle and the information exchange is similar to those for single round DS-TWR. The BS measures ToF by averaging over multiple rounds of transmission and reception. For instance, the ToF can be calculated as

$$ToF = \frac{1}{N} * {\sum }_{i = 1}^{N} {ToF}_{i} ,$$

where ToFᵢ=T_{RX}ⁱ−T_{TX}ⁱ, is the ToF of the i-th round. The i-th ToF can be measured as

$${ToF}_{i} = \frac{( {T}_{round \_ i} * {T}_{round \_ i + 1} - {T}_{reply \_ i} * {T}_{reply \_ i + 1} )}{( {T}_{round \_ i} + {T}_{round \_ i + 1} + {T}_{reply \_ i} + {T}_{reply \_ i + 1} )} .$$

Alternatively, the i-th ToF can be measured as

$${ToF}_{i} = \frac{( {T}_{round \_ 2 i - 1} * {T}_{round \_ 2 i} - {T}_{reply \_ 2 i - 1} * {T}_{reply \_ 2 i} )}{( {T}_{round \_ 2 i - 1} + {T}_{round \_ 2 i} + {T}_{reply \_ 2 i - 1} + {T}_{reply \_ 2 i} )} .$$

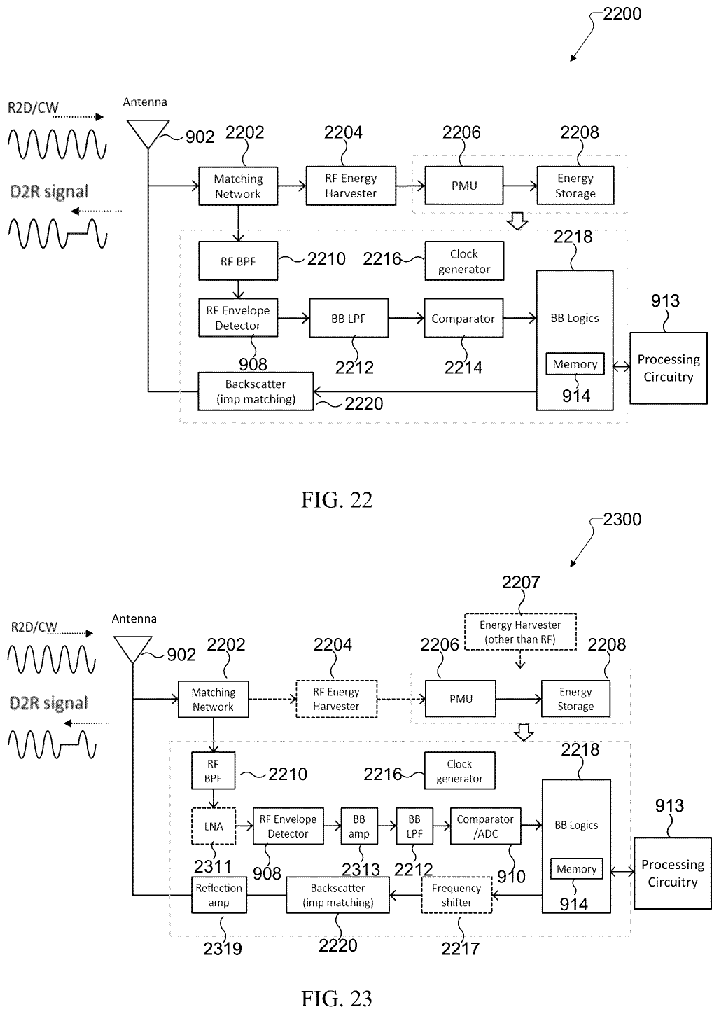

FIG. 22 illustrates a diagram of an example type-1 backscatter structure 2200 for IoT devices according to embodiments of the present disclosure. For example, Type-1 backscatter structure 2200 for IoT devices can be implemented by a UE, such as UE 114 of FIG. 1, or may be devices with fewer components and functionality than a UE. This example is for illustration only and other embodiments can be used without departing from the scope of the present disclosure.

As shown in FIG. 22, type-1 backscatter structure 2200 for IoT devices includes an antenna 902, a matching network 2202, a RF energy harvester 2204, a power management unit (PMU) 2206, an energy storage 2208, a RF BPF 2210, a clock generator 2216, a RF envelope detector 908, a baseband low pass filter (BB LPF) 2212, a comparator 2214, a BB logistics 2218, a memory 914, processing circuitry 913, and a backscatter (impedance matching) 2220.

FIG. 23 illustrates a diagram of an example type-2a backscatter structure 2300 for IoT devices according to embodiments of the present disclosure. For example, type-2a backscatter structure 2300 for IoT devices can be implemented by a UE, such as UE 115 of FIG. 1, or may be devices with fewer components and functionality than a UE. This example is for illustration only and other embodiments can be used without departing from the scope of the present disclosure.

As shown in FIG. 23, type-2a backscatter structure 2300 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a RF envelope detector 908, a BB amplifier 2313, a baseband low pass filter (BB LPF) 2212, a comparator/ADC 910, a BB logistics 2218, a memory 914, processing circuitry 913, a frequency shifter 2217, a backscatter (impedance matching) 2220, and a reflection amplifier 2319.

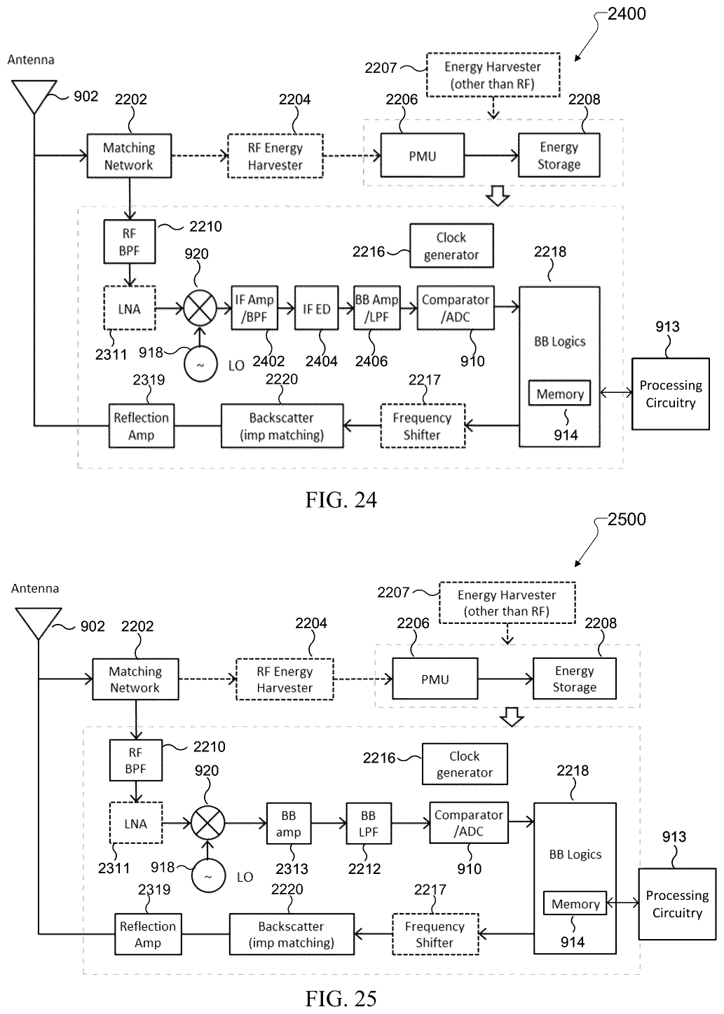

FIG. 24 illustrates a diagram of an example type-2a backscatter structure 2400 for IoT devices according to embodiments of the present disclosure. For example, type-2a backscatter structure 2400 for IoT devices can be implemented by a UE, such as UE 116 of FIG. 1, or may be devices with fewer components and functionality than a UE. This example is for illustration only and other embodiments can be used without departing from the scope of the present disclosure.

As shown in FIG. 24, type-2a backscatter structure 2400 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a mixer 920, a LO 918, an IF amplifier/BPF 2402, an IF envelope detector 2404, a BB amplifier/LPF 2406, a comparator/ADC 910, a BB logistics 2218, a memory 914, processing circuitry 913, a frequency shifter 2217, a backscatter (impedance matching) 2220, and a reflection amplifier 2319.

FIG. 25 illustrates a diagram of an example type-2a backscatter structure 2500 for IoT devices according to embodiments of the present disclosure. For example, type-2a backscatter structure 2500 for IoT devices can be implemented by a UE, such as UE 116 of FIG. 3, or may be devices with fewer components and functionality than a UE. This example is for illustration only and other embodiments can be used without departing from the scope of the present disclosure.

As shown in FIG. 25, type-2a backscatter structure 2500 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a mixer 920, a LO 918, a BB amplifier 2313, BB LPF 2212, a comparator/ADC 910, a BB logistics 2218, a memory 914, processing circuitry 913, a frequency shifter 2217, a backscatter (impedance matching) 2220, and a reflection amplifier 2319.

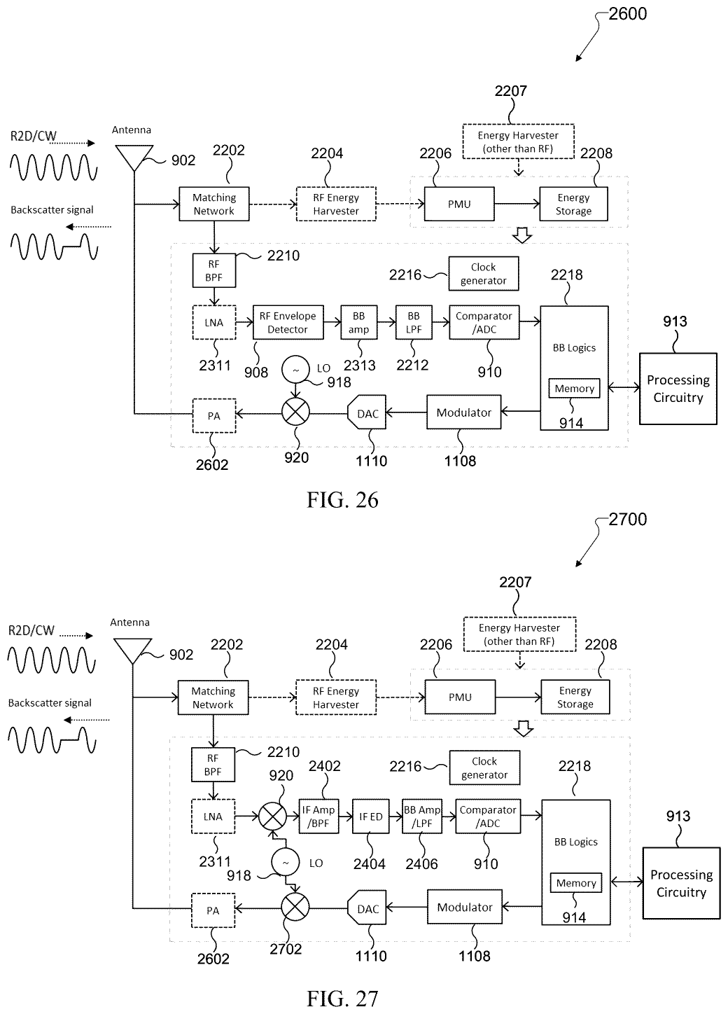

FIG. 26 illustrates a diagram of an example type-2b backscatter structure 2600 for IoT devices according to embodiments of the present disclosure. For example, type-2b backscatter structure 2600 for IoT devices can be implemented by a UE, such as UE 111 of FIG. 1, or may be devices with fewer components and functionality than a UE. This example is for illustration only and other embodiments can be used without departing from the scope of the present disclosure.

As shown in FIG. 26, type-2b backscatter structure 2600 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a mixer 920, a LO 918, a RF envelope detector 908, a BB amplifier 2313, BB LPF 2212, a comparator/ADC 910, a BB logistics 2218, a memory 914, processing circuitry 913, a modulator 1108, a DAC 1110, and a power amplifier (PA) 2602.

FIG. 27 illustrates a diagram of an example type-2b backscatter structure 2700 for IoT devices according to embodiments of the present disclosure. For example, type-2b backscatter structure 2700 for IoT devices can be implemented by a UE, such as UE 112 of FIG. 1, or may be devices with fewer components and functionality than a UE. This example is for illustration only and other embodiments can be used without departing from the scope of the present disclosure.

As shown in FIG. 27, type-2b backscatter structure 2700 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a mixer 920, a LO 918, IF amplifier/BPF 2402, IF ED 2404, a BB amplifier/LPF 2406, a comparator/ADC 910, a BB logistics 2218, a memory 914, processing circuitry 913, a modulator 1108, a DAC 1110, a mixer 2702, and a power amplifier (PA) 2602.

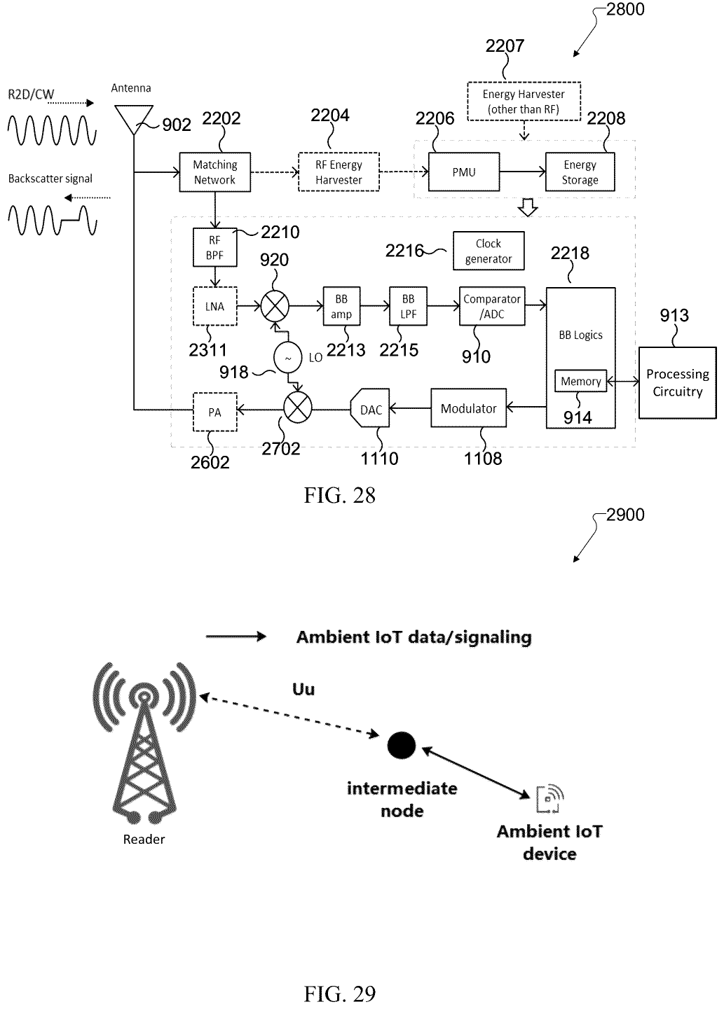

FIG. 28 illustrates a diagram of an example type-2b backscatter structure 2800 for IoT devices according to embodiments of the present disclosure. For example, type-2b backscatter structure 2800 for IoT devices can be implemented by a UE, such as UE 113 of FIG. 1, or may be devices with fewer components and functionality than a UE. This example is for illustration only and other embodiments can be used without departing from the scope of the present disclosure.

As shown in FIG. 28, type-2b backscatter structure 2800 for IoT devices includes an antenna 902, a matching network 2202, a RF energy harvester 2204, a PMU 2206, an energy harvester (other than RF) 2207, an energy storage 2208, a RF BPF 2210, a LNA 2311, a clock generator 2216, a mixer 920, a LO 918, IF amplifier/BPF 2402, IF ED 2404, a BB amplifier/LPF 2406, a comparator/ADC 910, a BB logistics 2218, a memory 914, processing circuitry 913, a modulator 1108, a DAC 1110, a mixer 2702, and a power amplifier (PA) 2602.

Several different types of A-IoT devices can be considered as following.
Device 1: ˜1 μW peak power consumption, has energy storage, initial sampling frequency offset (SFO) up to 10×ppm, neither R2D nor D2R amplification in the device. The device's D2R transmission is backscattered on a carrier wave provided externally.
Device 2a: ≤ a few hundred μW peak power consumption, has energy storage, initial sampling frequency offset (SFO) up to 10×ppm, both R2D and/or D2R amplification in the device. The device's D2R transmission is backscattered on a carrier wave provided externally.
Device 2b: ≤ a few hundred μW peak power consumption, has energy storage, initial sampling frequency offset (SFO) up to 10×ppm, both R2D and/or D2R amplification in the device. The device's D2R transmission is generated internally by the device.

The devices may operate in FDD spectrum or TDD spectrum, which may be licensed or unlicensed.

In the following, reference architectures for the device types herein are provided, which should be understood as an example and not as a restriction.

With reference to FIG. 22 an example Type-1 backscatter device structure according to the disclosure is shown.

The RF energy harvester via RF energy harvesting module 904 converts RF signal to DC power and supplies to the device. Either a R2D signal or an externally provisioned CW signal for backscattering can be utilized for RF energy harvesting. The CW is externally provided from a R2D or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network is to match impedance between antenna and other components. Power management unit (PMU) manages storing energy to energy storage from energy harvester and suppling power to active component blocks which needs power supply. Clock generator provides required clock signal(s).

The R2D signal is demodulated using a low complexity envelop detector and comparator, whose output is provided as an input to the baseband circuit. Given the low-power and low-complexity requirements of the Type-1 backscatter device, an RF envelop detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) for an adjacent channel interference suppression, and then the filtered RF signal is directly converted into a baseband using an RF envelop detector, followed by a baseband low-pass filter (LPF) for filtering out harmonics and high frequency components, and an n-bit comparator, where n can be 1, 2, 4, 8, . . . . The use of filters, e.g., BPF only, LPF only, or both, can be an implementation choice.

For the D2R backscatter transmission, any of the following can be used:
Case 1) CW is provisioned at DL spectrum and backscattered, i.e., CW @ R2D spectrum, D2R backscattering @ DL spectrum.
Case 2) CW is provisioned at UL spectrum and backscattered, i.e., CW @ D2R spectrum, D2R backscattering @ D2R spectrum.
Case 3) CW is provisioned at DL spectrum, frequency shifted to UL spectrum, and then backscattered, i.e., CW @ R2D spectrum, D2R backscattering @ D2R spectrum.

In one example, Case 1) or Case 2) is considered for device 1, i.e., CW and D2R backscattering on the same frequency and, therefore, a frequency shifter (FS) is not required.

Depending on the matched load impedance, the matching circuit can backscatter the incoming CW signal with different reflection coefficients in both amplitude and phase. In general, ASK/PSK/frequency shift keying (FSK) may be supported using an impedance matching circuit. As a simplest modulation scheme, OOK may be considered. The device may indicate its modulation capability or impedance matching capability to the network, or certain requirement may be predefined in the specification of system operation.

With reference to FIG. 23, an example device 2a architecture based on RF envelop detection according to the disclosure is shown.

The device 2a may share similar structure at large with device 1 as the D2R transmission is still based on backscattering of an externally provided CW, while the device 2a may differ from device 1 from the following aspects.

The device 2a has ≤ a few hundred μW peak power consumption and both DL and/or UL amplification in the device. In this case, alternative to the RF energy harvesting from a R2D signal or an externally provided CW signal, other renewable energy sources, e.g., solar, thermal, kinetic, etc., may be considered for energy harvesting. The presence of a certain energy harvesting capability from a certain renewable energy source may be assumed for system design point of view. The use of energy harvesters, e.g., RF energy harvester only, other energy harvester only, or both, can be an implementation choice.

The device 2a may be equipped with both R2D and/or D2R amplification in the device. Given the power consumption requirement, i.e., ≤ a few hundred μW, the D2R/R2D amplification for device 2a may be based on an architecture that is different from the common power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelop detector, baseband amplification after the envelop detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be assumed that 10˜25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be considered for Case 3). With FS, it can be assumed that the CW is provided in a frequency different than the D2R carrier frequency.

The device 2a receiver architecture may be based on RF envelop detector, intermediate frequency (IF) envelop detector, i.e., heterodyne receiver, or homodyne receiver with zero IF, as exemplified for device 2b.

With reference to FIG. 24, an example device 2a architecture based on IF envelop detection according to the disclosure is shown.

With reference to FIG. 25, an example device 2a architecture based on baseband detection according to the disclosure is shown.

With reference to FIG. 26, an example device 2b architecture based on RF envelop detection according to the disclosure is shown.

With reference to FIG. 27, an example device 2b architecture based on heterodyne/IF-ED receiver according to the disclosure is shown.

With reference to FIG. 28, an example device 2b architecture based on homodyne/zero-IF receiver according to the disclosure is shown.

The device 2b shares similar structure at large with the device 2a other than the D2R signal is internally generated using LO rather than backscattering the externally provided CW. The example architecture shown in FIGS. 24-26 is based on a common active transmitter chain, wherein the D2R data is modulated, converted to an analog signal using digital to analog converter (DAC) and, then up-converted to a D2R carrier frequency using LO and frequency mixer, which is followed by an amplifier.

In FIG. 24, the R2D receiver chain is still based on the RF envelop detector as in the previous architectures. In FIG. 25, the R2D receiver chain is based on heterodyne receiver with IF envelop detector. In the heterodyne architecture, the RF signal is down converted into an intermediate frequency and then detected using an envelope detector. In FIG. 26, the R2D receiver is based on homodyne receiver, i.e., zero-IF. In the homodyne/zero-IF architecture, the RF signal is directly down converted into baseband signal and then detected using a comparator/ADC.

FIGS. 10, 22, 23, 24, 25, and 26 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

FIG. 29 illustrates an example system 2900 for D2R/R2D transmission according to embodiments of the present disclosure. For example, system 2900 can be implemented in the wireless network 100 of FIG. 1. This example is for illustration only and other embodiments can be used without departing from the scope of the present disclosure.

With reference to FIG. 29, a topology is shown involving an intermediate node, wherein the intermediate node (I-node) can be any of a UE, relay, repeater, a dedicated node, or a gNB. Any operations performed by a BS can be also performed by the I-node instead of the BS, and each or part of interfaces are transparent to the A-IoT devices.

An entity directly communicating with a device, or tag, is collectively termed as a reader, which can be an intermediate node as illustrated in FIG. 29, an assisting node, a UE, or a BS directly communicating with a device.

This disclosure is applicable to any of the following spectrum options, wherein a reader can be any of a BS, an intermediate node, an assisting node, or a UE in any of the topologies or scenarios disclosed herein:
CW is transmitted on R2D spectrum and D2R is transmitted on the R2D spectrum or shifted to D2R spectrum.
CW is transmitted on D2R spectrum and D2R is transmitted on the D2R spectrum or shifted to R2D spectrum.
R2D transmission by a reader is on R2D spectrum or D2R spectrum.
A node transmitting the CW can be a node inside the topology, e.g., a BS, an intermediate node, an assisting node, or a UE (e.g., the UE 116), or a node outside the topology, e.g., a dedicated CW source.
A reader receiving D2R transmission and a reader transmitting R2D may be the same or different.
As an example, CW is transmitted on R2D spectrum and D2R transmission is shifted to D2R spectrum, wherein the node transmitting the CW is a node inside topology or outside topology, and a reader transmitting R2D and a reader receiving D2R may be the same or different.
As another example, CW is transmitted on R2D or D2R spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions herein:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

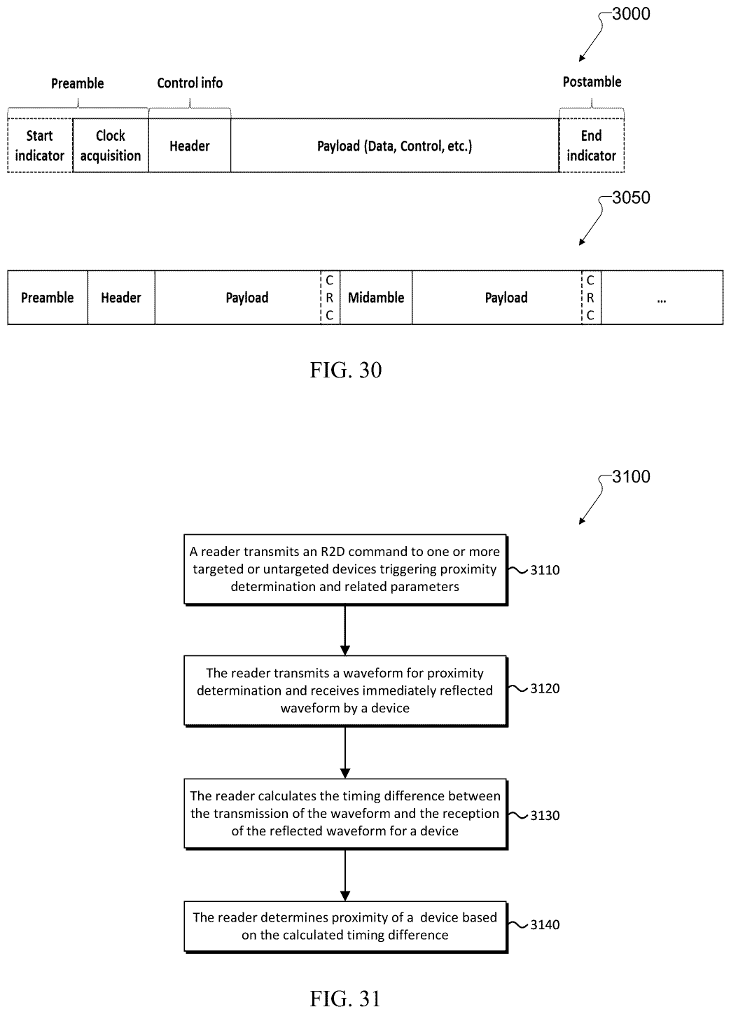

FIG. 30 illustrates example signal structures 3000 and 3050 according to embodiments of the present disclosure. For example, signal structures 3000 and 3050 can be utilized by a UE, such as UE 112 of FIG. 1, or may be devices with fewer components and functionality than a UE, and/or a BS 102/reader. This example is for illustration only and other embodiments can be used without departing from the scope of the present disclosure.

With reference to FIG. 30, an example signal structure used for A-IoT system for R2D or D2R transmission according to the disclosure is shown. The dotted block indicates that it may or may not exist.

The first figure in FIG. 30 3000 illustrates a general signal structure comprised of one or more of the following elements:
Start/End-indicator, i.e., delimiter: Start-of-signal and end-of-signal indication. It may be a short duration of low voltage signal or a sequence with low detection complexity prior to detecting preamble, e.g., high/low voltage patterns. The start-indicator is a part of the preamble. The end-indicator may be also termed as postamble. The delimiters may or may not be exist.
Clock acquisition: A sequence that provides OOK chip rate acquisition, which is used to detect OOK chips for the rest of the signal, and the chip synchronization. The clock acquisition part is a part of preamble.
Header: The header field carries necessary information for R2D or D2R signal reception, providing L1 or L2 control information
Payload: The field provides data including any of L1, L2, or higher layer control information, system information, etc.

The second figure in FIG. 30 3050 illustrates a signal structure with midamble. When a transmission is longer than a certain threshold, which may be predefined in a specification of system operations or indicated to the device for reception or transmission from the device, the payload may be divided into multiple segments with midamble. A single header for the entire payload, or one or more headers for each segments of the payload may be provided. A single CRC for the entire payload (either inclusive or non-inclusive of the header) or one or more CRCs for each segments of the payload may be provided.

This disclosure relates to proximity determination of A-IoT devices. In general, positioning is to determine a 2D coordinate of a device, which requires at least two or more TRPs, while ranging is to determine a distance to the device, i.e., proximity determination, which can be performed with single TRP.

For an inventory as an examples, there are use cases, e.g., logistics, that require a proximity determination of devices such that the device can be located. However, a device may be lacking a precise timing maintenance capability due to low quality LO and intermittent availability of the energy. Therefore, there is a need to define procedures and methods for proximity determination of a device, which does not require a precise timing capability of a device.

A device may be also lacking a computation capability to perform measurements of a received signal or determine the proximity by itself. Therefore, there is a need to define procedures and methods for proximity determination of a device, which does not require a computation capability of a device. One example of such procedures or methods is based on a reader-side transmission power control. Another example of such procedures and methods is based on a reader-side measurements of a signal from a device.

On the other hand, a topology may include more than one readers, each for transmission or reception, respectively. Furthermore, a reader may be an intermediate UE associated with a serving gNB. Therefore, there is a need to define procedures and methods for proximity determination of a device considering various topologies.

The disclosure relates to a communication system. The disclosure relates to defining functionalities and procedures for determining a proximity to A-IoT devices whose D2R transmission is based on backscattering or based on internally generated signal but lacking a precise timing capability.

The disclosure also relates to defining functionalities and procedures for a reader to determine a proximity of a device based on immediate reflection by a device and the transmission and reception timing difference measurement by a reader.

The disclosure further relates to defining functionalities and procedures for a reader to determine a proximity of a device based on reader transmit power control.

The disclosure also relates to defining functionalities and procedures for a reader to determine a proximity of a device based on reader-side measurements of a received signal from a device.

Embodiments of the disclosure for determining a proximity to a device whose D2R transmission is based on backscattering or based on internally generated signal but lacking a precise timing capability are summarized in the following and are fully elaborated further herein.
Method and apparatus for defining functionalities and procedures for a reader to determine a proximity of a device based on immediate reflection by a device and the transmission and reception timing difference measurement by a reader.
Method and apparatus for defining functionalities and procedures for a reader to determine a proximity of a device based on reader transmit power control.
Method and apparatus for defining functionalities and procedures for a reader to determine a proximity of a device based on reader-side measurements of a received signal from a device.

FIG. 31 illustrates a flowchart of an example procedure 3100 for proximity determination according to embodiments of the present disclosure. For example, procedure 3100 can be performed by any of the reader devices described herein. This example is for illustration only and other embodiments can be used without departing from the scope of the present disclosure.

In step 1, a reader transmits an R2D command to one or more targeted or untargeted devices triggering proximity determination and related parameters 3110. In one example, this step is skipped.

In step 2, the reader transmits a waveform for proximity determination and receives immediately reflected waveform by a device 3120. For this step, a device performs an immediate reflection of the incoming waveform. The waveform can be a CW signal, which may be agnostic to the devices. The transmitted waveform by the reader may be unmodulated. In another example, the transmitted waveform by the reader is modulated by encoding a certain sequence for timestamping, i.e., to recognize a timing.

For the differentiation of the received reflected waveform at the reader, each device may encode a certain sequence, i.e., a signature, on the reflected waveform. An index of a sequence from a set of sequences may be provided to one or more targeted devices, respectively, in step 1. In another example, the sequence is associated with each devices' own ID without any separate indication from the reader in step 1.

In step 3, the reader calculates the timing difference between the transmission of the waveform and the reception of the reflected waveform for a device 3130. For the differentiation of the received reflected signal from a device from those from other devices, the sequence encoded on the waveform by each device can be utilized by the reader.

In step 4, the reader determines proximity of a device based on the calculated timing difference 3140. If there are two separate readers, each for transmission and reception, the receiving reader provides received signal timing information to the transmitting reader. Therefore, the transmitting reader can determine the timing difference based on its transmission timing and received reflect signal timing provide by the receiving reader.

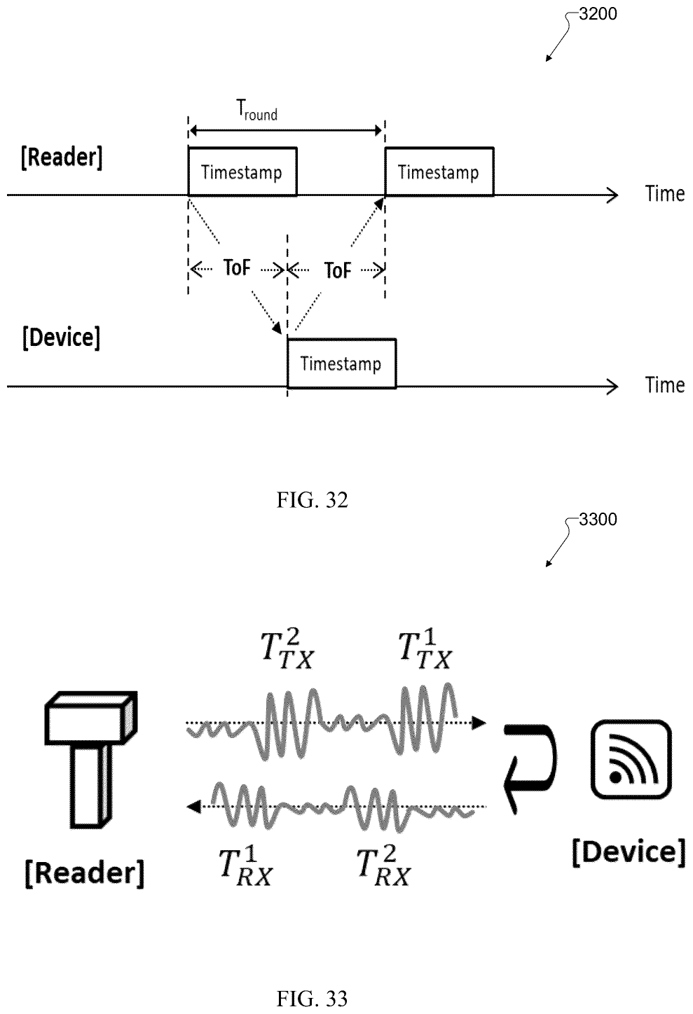

FIG. 32 illustrates a timeline 3200 for immediate reflection according to embodiments of the present disclosure. For example, timeline 3200 can be followed by any of the reader devices described herein and any of the devices described herein. This example is for illustration only and other embodiments can be used without departing from the scope of the present disclosure.

The general principle of proximity determination method based on immediate reflection by a device and timing measurement at a reader includes a R2D command from a reader indicating parameters related to proximity determination, and the reception of an immediately reflected signal by a device at the reader.

With reference to FIG. 31, an example flowchart for a reader to perform proximity determination based on timing measurement according to the disclosure is shown.

If the reader is an intermediate UE connected to a serving gNB (e.g., reader), the reader reports the proximity determination report to the serving gNB including a list of devices whose proximity is determined. The proximity determination report may also include the ranging results, such as in meters. If there are two separate readers and they are intermediate UEs connected to a serving gNB, The transmitting reader may report the transmission timing of the waveform to the serving gNB. Alternatively, the transmission timing of the waveform is indicated by the serving gNB to the transmitting reader such that separate indication from the transmitting reader to the serving gNB is unnecessary.

Some of the embodiments disclosed herein can be also applicable for a sensing application. In the case of sensing, the one or more targeted or untargeted devices are replaced by target objects for detection, which has no capability of communicating with the reader. Therefore, the step 1 is skipped, and the immediately reflected signal from one object may not be distinguishable from another object, as the objects do not have a capability of encoding a signal. The case of a single reader, transmitting the waveform and receiving the reflective waveform, can be viewed as a monostatic sensing. The case of two separate readers, each for transmission and reception, can be viewed as a bistatic sensing.

With reference to FIG. 32, an example of the immediate reflection scheme according to the disclosure is shown. As illustrated in the figure, a device receives a signal from a reader and reflects the receives signal immediately without a delay. The signal can be a CW waveform, or any signal from the reader, which is either modulated or unmodulated.

The R2D command in step 1 may indicate the following parameters:
Signal type indicating that it is for initiating proximity determination operation, i.e., a trigger.
A device ID or a device-group ID targeted for the proximity determination, or indication for untargeted proximity determination. For the untargeted proximity determination, any device receiving the R2D command participates the proximity determination process.
A time duration for immediately reflecting the received signal. The time duration can be indicated by an offset from the reception of the R2D command and a duration, wherein the offset and the duration can be indicated in terms of a certain time unit, e.g., second, millisecond, microsecond, a basic time unit, Tₛ, symbol, or slot, etc.
Power control parameter, such as full power reflection, certain power reduction, or power boosting which may be only applicable for a device type equipped with an amplifier. The indication can be provided in dB, or by an index from a set of predefined power reduction or boosting values.

FIG. 33 illustrates an example system 3300 for signal transmission and reception according to embodiments of the present disclosure. For example, system 3300 can be implemented in the wireless network 100 of FIG. 1. This example is for illustration only and other embodiments can be used without departing from the scope of the present disclosure.

With reference to FIG. 33, an example signal transmission and reception including a timestamp according to the disclosure is shown. The signal may be modulated with a certain time pattern or sequence for recognizing the returning signal timing, i.e., timestamp.

With a timestamp, the reader calculates the ToF as ToF=T_{RX}¹−T_{TX}¹, where T_{TX}¹ and T_{RX}¹ are transmit and receive times of a first timestamp. A time pattern may be repeated one or multiple times. In one example, the transmitted signal includes more than one timestamps. In this case, the ToF can be averaged over multiple rounds of transmission and reception.

The reader may also measure RSRP, RSSI, RSRQ, or SINR from the returned reflected signal and utilize the measurement for proximity determination. The pathloss can be measured by the reader as PL=(Pₜₓ−Pᵣₓ+Attn)/2, wherein Pₜₓ is the signal transmission power from a reader and Pᵣₓ is a received power of the reflected signal by a device at the reader. Attn is the total attenuation at the device, which is measured as a difference between the received signal power and the reflected signal power at the corresponding device. The device may report the Attn value to the reader, which may be in dB, or using an index from a set of predefined values or range of values. Using the measured PL and a pathloss equation for the given environment, which is a function of a distance and the frequency, the reader can determine a proximity to the device.

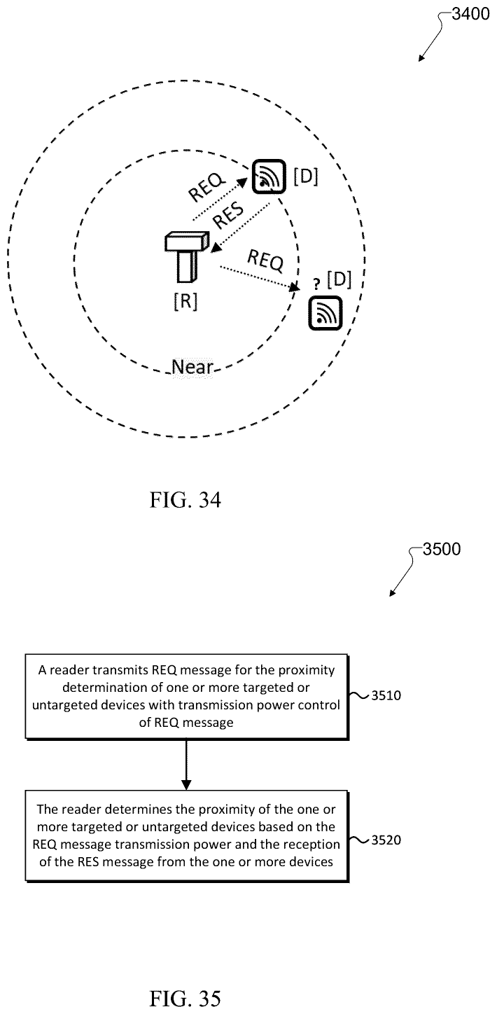

FIG. 34 illustrates an example system 3400 for proximity determination according to embodiments of the present disclosure. For example, system 3400 can be implemented in the wireless network 100 of FIG. 1. This example is for illustration only and other embodiments can be used without departing from the scope of the present disclosure.

FIG. 35 illustrates a flowchart of an example procedure 3500 for proximity determination according to embodiments of the present disclosure. For example, procedure 3500 can be performed by any of the reader devices described herein. This example is for illustration only and other embodiments can be used without departing from the scope of the present disclosure.

In step 1, a reader transmits Request (REQ) message for the proximity determination of one or more targeted or untargeted devices with transmission power control of REQ message 3510. In step 2, the reader determines the proximity of the one or more targeted or untargeted devices based on the REQ message transmission power and the reception of the Response (RES) message from the one or more devices 3520.

The general principle of proximity determination method based on a reader transmit power control includes a reader transmitting a message with a reduced power, which can be only heard by a proximity devices, and based on a reception of a response message from the proximity device.

With reference to FIG. 34, an example method of proximity determination based on a reader transmit power control according to the disclosure is shown.

With reference to FIG. 35, an example flowchart for a reader to perform proximity determination based on transmit power control according to the disclosure is shown.

Reader transmits REQ message for probing and a device transmits RES message. The REQ and the RES message may be dedicated messages designed for the proximity determination or they may be reused from the messages defined for an inventory process, such as triggering message from a reader, which initiates a random access round of an inventory process, and the response message from a device, including device ID. In this case, the proximity determination becomes two-step inventory process including a trigger message from a reader and a response message from a device providing the device ID in the respond message. There may be further subsequent steps such as for acknowledgement and additional information exchange between the reader and the device. In one example, the header fields of the PRDCH and the PDRCH indicates a specific codepoint to indicate that the corresponding transmission is for REQ and for RES messages for proximity, respectively.

In one embodiment, the reader sets the REQ transmission power such that only a nearby device can hear. The transmission power of the REQ message may be predefined in a specification of a system operation, e.g., in terms of dBm, mW, dB, or W, or determine by the reader itself.

The REQ message may include a device ID or a device group ID for the proximity determination of a targeted device or a group of devices. For the targeted case, the REQ message may include a dedicated resource, e.g., in time, frequency, or code domain, for the device to respond with the RES message, i.e., a contention free random access.

One example of a code-domain dedicated resource is a sequence. A targeted device is indicated a sequence from a set of sequences via an index for RES transmission. For instance, the RES transmission is a sequence modulated on the CW waveform. Another example of a code-domain dedicated resource is a preamble index from a set of preambles. A targeted device is indicated a preamble index from a set of preambles. In this case, the RES transmission is a transmission of the indicated preamble. An indicated sequence from a set of sequences or a preamble from a set of preambles to a targeted device may be distinguished from one to another such that the proximity for device(s) can be uniquely identified. One example of a time-domain dedicated resource can be a time slot index from a set of time slots. One example of a frequency-domain dedicated resource can be a small frequency shift factor, e.g., for Miller encoding which can be realized in the baseband.

The proximity determination may be also for unknown devices. In this case, the REQ message may not include a specific device ID, or it may indicate NULL. The REQ message may also include any additional information requested to the device to include in the RES message, such as a device type, device status, energy level, etc.

If the topology includes two separate readers for transmission and reception, respectively, the receiving reader sends the proximity determination report to the transmitting reader.

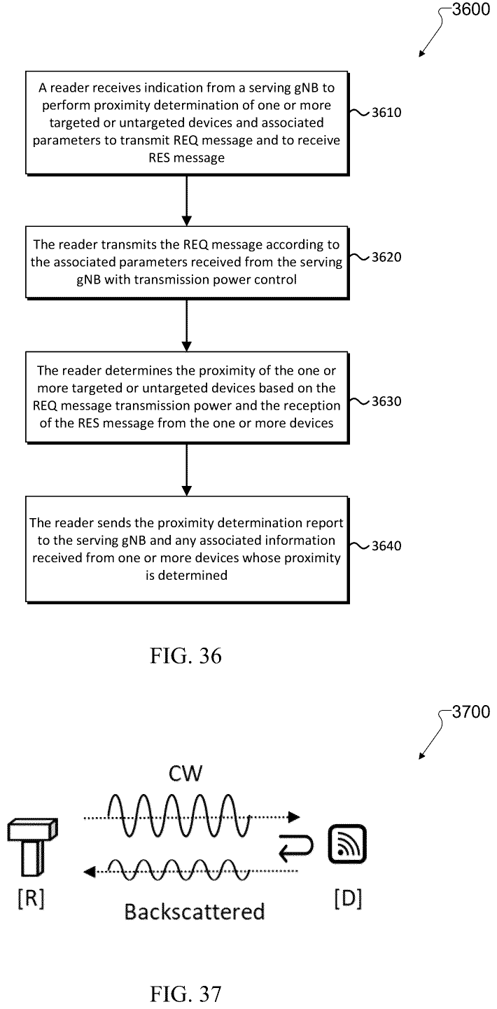

FIG. 36 illustrates a flowchart of an example procedure 3600 for proximity determination according to embodiments of the present disclosure. For example, procedure 3600 can be performed by any of the reader devices described herein. This example is for illustration only and other embodiments can be used without departing from the scope of the present disclosure.

In step 1, a reader receives indication from a serving gNB to perform proximity determination of one or more targeted or untargeted devices and associated parameters to transmit REQ message and to receive RES message 3610. In step 2, the reader transmits the REQ message according to the associated parameters received from the serving gNB with transmission power control 3620. In step 3, the reader determines the proximity of the one or more targeted or untargeted devices based on the REQ message transmission power and the reception of the RES message from the one or more devices 3630. In step 4, the reader sends the proximity determination report to the serving gNB and any associated information received from one or more devices whose proximity is determined 3640.

With reference to FIG. 36, an example flowchart for an intermediate reader to perform proximity determination based on transmit power control according to the disclosure is shown.

If the reader is an intermediate UE, the REQ transmission power may be determined by the intermediate UE (e.g., the UE 116) itself and reported to the serving gNB, or the reader receives indication from the gNB on the REQ transmission power and follows the indication from the gNB. In both approaches, the indication can be in terms of dBm, mW, dB, or W.

The reader receives an indication from the serving gNB to perform the proximity determination. The indication from the serving gNB may include the following information:
Transmission power of the REQ message as disclosed herein.
Whether it is a targeted or untargeted device proximity determination.
A device ID or a device group ID for the case of the targeted device proximity determination.
A dedicated resource, e.g., in time, frequency, or code domain, for the transmission of the REQ message.
A dedicated resource, e.g., in time, frequency, or code domain, for the transmission of the RES message by one or more devices, which is indicated by the reader to targeted or untargeted devices.
Any additional information requested from the gNB to the reader.

A device responds to the reader with the RES message in response to the received REQ message. The RES message may include the following information:
Device ID, which may be associated with an assigned device ID or permanent device ID, e.g., protocol control (PC), extended protocol control (XPC), electronic product code (EPC).
The RSRP, RSRQ, RSSI, or SINR of the received REQ message.
Any additional information related to the device, such as device type, or an information requested by the reader in the REQ message.

If the topology includes two separate readers for transmission and reception, respectively, the receiving reader sends the proximity determination report to the transmitting reader or to the serving gNB.

FIG. 37 illustrates an example system 3700 for proximity determination according to embodiments of the present disclosure. For example, system 3700 can be implemented in the wireless network 100 of FIG. 1. This example is for illustration only and other embodiments can be used without departing from the scope of the present disclosure.

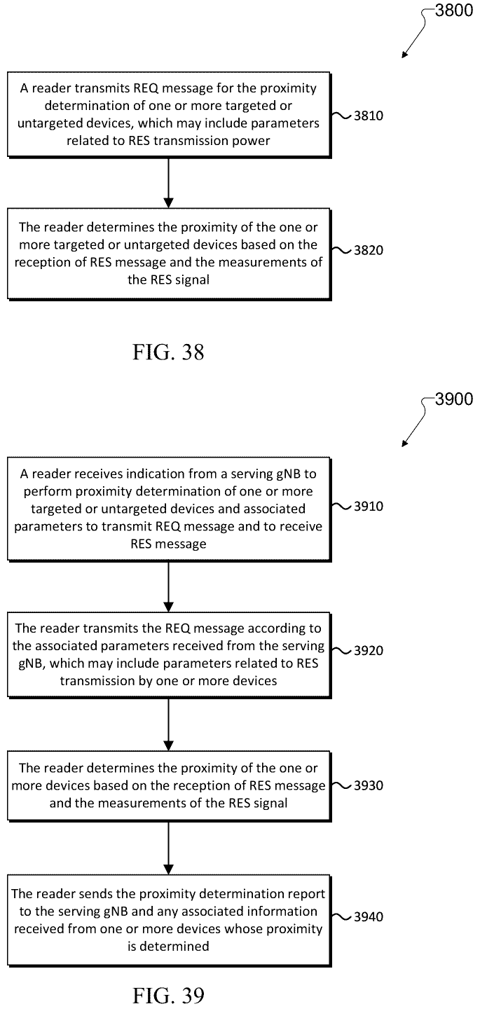

FIG. 38 illustrates a flowchart of an example procedure 3800 for proximity determination according to embodiments of the present disclosure. For example, procedure 3800 can be performed by any of the reader devices described herein. This example is for illustration only and other embodiments can be used without departing from the scope of the present disclosure.

In step 1, a reader transmits REQ message for the proximity determination of one or more targeted or untargeted devices, which may include parameters related to RES transmission power 3810. In step 2, the reader determines the proximity of the one or more targeted or untargeted devices based on the reception of RES message and the measurements of the RES signal 3820.

The general principle of proximity determination method based on a measurement at a reader includes a reader performing a measurement of the received signal power from a device and determining the proximity based on the measurement at the reader. The measurement includes any of RSRP, RSRQ, RSSI or SINR.

With reference to FIG. 37, an example method of proximity determination based on a measurement at a reader according to the disclosure is shown.

The illustration is provided for a Type 1, passive devices. However, the methods disclosed herein can be also applicable for other types of devices such Type 2a and 2b devices. The method may be also applicable for a topology that involves two separate readers for transmission and reception, respectively. The method may be further applicable for topology that includes an intermediate UE reader, associated with a serving gNB.

With reference to FIG. 38 an example flowchart for a reader to perform proximity determination based on measurement at the reader according to the disclosure is shown.

A reader transmits REQ message for the proximity determination of one or more targeted or untargeted devices. The reader determines the proximity of the one or more targeted or untargeted devices based on the measurements of the RES signal from the one or more devices responding to the REQ message. The REQ and the RES messages may be dedicated messages designed for the proximity determination or they may be reused from the messages previously defined, e.g., for an inventory process, as disclosed herein.

The REQ message may include a device ID or a device group ID for the proximity determination of a targeted device or a group of devices. For the targeted device or a group of devices, the REQ message may include a dedicated resource, e.g., in time, frequency, or code domain, for the device to respond with the RES message, i.e., a contention free random access. The proximity determination may be also for unknown devices. In this case, the REQ message may not include a specific device ID, or it may indicate NULL. In this case, the RES message transmission can be based on contention-based random access. The REQ message may also include any additional information requested to the device to provide in the RES message, such as device type, device status, energy level, etc.

A device responds to the reader with the RES message in response to the received REQ message. The RES message may include device ID, which may be associated with an assigned device ID or permanent device ID, e.g., PC, XPC, EPC, and any additional information related to the device, such as device type, or information requested by the reader in the REQ message.

A Type 1 device transmits RES message via backscattering transmission without a capability of amplification. During the backscattering, there can be a backscattering loss of the transmitted signal compared to the incident CW power level. The backscattering loss can be different from one implementation to another implementation, depending on the impedance matching circuit and other losses such as cable loss, connector loss and so on. In one embodiment, the RES message from a device includes a backscattering loss value of the device. The reader determines the proximity of a device based on the measurement of the RES message and the reported backscattering loss value.

A Type 2a device transmits RES message via backscattering transmission with a capability of amplification. In one embodiment, a reader indicates a device in the REQ message a parameter related to the backscattering amplification gain. In one example, a reader may indicate a device to not to perform any power amplification, which may be also predefined in a specification of system operations without any explicit indication. In this cases, the device reports a backscattering loss value in the RES message, and the reader determines the proximity of the device based on the measurement of the RES message and the reported backscattering loss value. In another example, a reader may indicate a device to perform power amplification with an indicated amplification gain value, e.g., in terms of dB or an index from a set of predefined gain values. In this cases, the device reports a backscattering loss value in the RES message, and the reader determines the proximity of the device based on the measurement of the RES message, indicated amplification gain and the reported backscattering loss value. Alternatively, the amplification gain may be inclusive of the backscattering loss after compensating the loss. Therefore, the determination of the proximity of a device is only based on the measurement of the RES message and the indicated amplification gain without involving reporting of the backscattering loss value. If the device is unable to meet the indicated amplification gain, the device may report the actual amplification gain in the RES message used for the transmission. In yet another example, a device may determine the amplification gain by itself, e.g., based on the available energy level of the device, then the device reports a resulting gain (or loss) value from both the chosen amplification gain and the backscattering loss. The resulting gain (or loss) may be indicated in dB or via an index from a set of predefined values. Therefore, the reader determines the proximity of the device based on the measurement of the RES message and the reported backscattering gain (or loss) value.

A Type 2b device transmits RES message via internally generated signal using LO and an amplifier. In one example, the transmission power of the RES message may be predefined in a specification of system operations, e.g., in terms of dBm, μW, mW, etc. In another example, the reader may indicate the transmission power of the RES message to the device, e.g., in terms of dBm, μW, mW, etc. In both cases, if the device is unable to meet the transmission power due to energy level of the device, the device may report the actual transmission power in the RES message used for the transmission. In yet another example, the device may determine the transmission power of the RES message by itself, and reports the determined transmission power value in the RES message, e.g., in terms of dBm, μW, mW, etc. For device type 2b, a reader determines the proximity of the device based on the measurement of the received RES signal and the RES transmission power by the device.

If the topology includes two separate readers for transmission and reception, respectively, the receiving reader sends the proximity determination report to the transmitting reader. In one example, a proximity determination report includes a list of device IDs whose proximity has been determined. In addition, the report may also include determined proximity of the one or more devices, e.g., in terms of meters, and any additional information received from the one or more devices. In another example, the proximity determination report provides raw data such as the detected device IDs, measurements of the corresponding RES signal, e.g., RSRP, RSRQ, RSSI, or SINR, and related parameters, such as backscattering loss, amplification gain, and transmission power level. In this case, the final proximity determination is made at the transmitting node, which receives the proximity determination report from the receiving reader.

FIG. 39 illustrates a flowchart of an example procedure 3900 for proximity determination according to embodiments of the present disclosure. For example, procedure 3900 can be performed by any of the reader devices described herein. This example is for illustration only and other embodiments can be used without departing from the scope of the present disclosure.

In step 1, a reader receives indication from a serving gNB to perform proximity determination of one or more targeted or untargeted devices and associated parameters to transmit REQ message and to receive RES message 3910. In step 2, the reader transmits the REQ message according to the associated parameters received from the serving gNB, which may include parameters related to RES transmission by one or more devices 3920. In step 3, the reader transmits the REQ message according to the associated parameters received from the serving gNB, which may include parameters related to RES transmission by one or more devices 3930. In step 4, the reader sends the proximity determination report to the serving gNB and any associated information received from one or more devices whose proximity is determined 3940.

With reference to FIG. 39, an example flowchart for an intermediate UE reader to perform proximity determination based on measurement at the reader according to the disclosure is shown.

If the reader is an intermediate UE, the reader receives an indication from the serving gNB to perform the proximity determination. The indication from the serving gNB may include a list of information as disclosed herein. In addition, the indication from the serving gNB may also include parameters related to the transmission power control such as parameters related to backscattering amplification gain, e.g., in terms of dB, or RES signal transmission power level, e.g., in terms of dBm, μW, mW, etc.

If the topology includes two separate readers for transmission and reception, respectively, the receiving reader sends the proximity determination report to the transmitting reader or to the serving gNB. The proximity determination report can be disclosed herein.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a first reader to determine a proximity of a target device, the method comprising:
determining parameters related to transmission of a physical reader-to-device channel (PRDCH);
determining parameters related to transmission of a physical device-to-reader channel (PDRCH) by the target device;
transmitting the PRDCH, wherein the PRDCH includes at least one of:
information related to the target device providing:
a device identifier corresponding to the target device,
a device-group identifier corresponding to a group of target devices including the target device, or
no identifier corresponding to all devices receiving the PRDCH, and
the parameters related to the PDRCH transmission;
receiving:
the PDRCH from the target device, or
from a second reader, a proximity determination report associated with the target device; and
determining the proximity of the target device based on reception of the PDRCH or reception of the proximity determination report.

2. The method of claim 1, wherein:
the PRDCH transmitted by the first reader corresponds to a message for inventorying the target device, and
the PDRCH received from the target device is in response to the message for inventorying the target device.

3. The method of claim 1, wherein the PDRCH includes information related to at least one of:
a device identifier,
a device type,
a device status,
a device energy level,
a backscatter loss,
an amplification gain,
a transmission power,
a measurement from the PRDCH, and
additional data requested in the PRDCH.

4. The method of claim 1, wherein determining the proximity of the target device based on reception of the PDRCH from the target device further comprises:
determining the proximity of the target device based on reception of the PDRCH from the target device including successful reception of the PDRCH, or
determining the proximity of the target device based on reception of the PDRCH from the target device including (i) successful reception of the PDRCH, and (ii) a measurement based on a signal received from the target device.

5. The method of claim 1, wherein the parameters related to the PDRCH transmission include at least one of:
a transmission timing,
a resource in time, frequency, or code domain,
information related to transmission power control, and
a request for an additional data transmission in the PDRCH.

6. The method of claim 1, wherein the proximity determination report includes at least one of:
one or more device identifiers of devices in proximity of the second reader,
a determined proximity range, and
a measurement associated with PDRCH transmissions received from the devices in proximity of the second reader.

7. The method of claim 1, further comprising:
receiving, from a base station (BS), a command to perform a proximity determination;
receiving, from the BS, information related to performing the proximity determination including at least one of:
one or more target devices,
the parameters related to the PRDCH transmission, and
the parameters related to the PDRCH transmission; and
transmitting the proximity determination report to the BS,
wherein determining the parameters related to the PRDCH transmission includes determining a PRDCH transmission power based on (i) reception of the information related to performing the proximity determination or (ii) an autonomous decision by the first reader.

8. A first reader, comprising:
a processor configured to:
determine parameters related to transmission of a physical reader-to-device channel (PRDCH); and
determine parameters related to transmission of a physical device-to-reader channel (PDRCH) by a target device; and
a transceiver operably coupled to the processor, the transceiver configured to:
transmit the PRDCH, wherein the PRDCH includes at least one of:
information related to the target device providing:
a device identifier corresponding to the target device,
a device-group identifier corresponding to a group of target devices including the target device, or
no identifier corresponding to all devices receiving the PRDCH, and
the parameters related to the PDRCH transmission; and
receive:
the PDRCH from the target device, or
from a second reader, a proximity determination report associated with the target device,
wherein the processor is further determine a proximity of the target device based on reception of the PDRCH or reception of the proximity determination report.

9. The first reader of claim 8, wherein:
the PRDCH transmitted by the first reader corresponds to a message for inventorying the target device, and
the PDRCH received from the target device is in response to the message for inventorying the target device.

10. The first reader of claim 8, wherein the PDRCH includes information related to at least one of:
a device identifier,
a device type,
a device status,
a device energy level,
a backscatter loss,
an amplification gain,
a transmission power,
a measurement from the PRDCH, and
additional data requested in the PRDCH.

11. The first reader of claim 8, wherein the processor is further configured to determine the proximity of the target device based on reception of the PDRCH from the target device based on:
reception of the PDRCH from the target device including (i) successful reception of the PDRCH and (ii) information provided in the PDRCH, or
reception of the PDRCH from the target device including (i) successful reception of the PDRCH, (ii) a measurement based on a signal received from the target device, and (iii) information provided in the PDRCH.

12. The first reader of claim 8, wherein the parameters related to the PDRCH transmission include at least one of:
a transmission timing,
a resource in time, frequency, or code domain,
information related to transmission power control, and
a request for an additional data transmission in the PDRCH.

13. The first reader of claim 8, wherein the proximity determination report includes at least one of:
one or more device identifiers of devices in proximity of the second reader,
a determined proximity range, and
a measurement associated with PDRCH transmissions received from the devices in proximity of the second reader.

14. The first reader of claim 8, wherein:
the transceiver is further configured to:
receive, from a base station (BS), a command to perform a proximity determination;
receive, from the BS, information related to performing the proximity determination including at least one of:
one or more target devices,
the parameters related to the PRDCH transmission, and
the parameters related to the PDRCH transmission; and
transmit the proximity determination report to the BS; and
the processor is further configured to determine a PRDCH transmission power based on (i) reception of the information related to performing the proximity determination or (ii) an autonomous decision by the first reader.

15. An internet of things (IoT) device, comprising:
a transceiver configured to:
receive, from a first reader, a physical reader-to-device channel (PRDCH), wherein the PRDCH includes at least one of:
information related to the IoT device providing:
a device identifier corresponding to the IoT device,
a device-group identifier corresponding to a group of devices including the IoT device, or
no identifier corresponding to all devices receiving the PRDCH, and
parameters related to transmission of a physical device-to-reader channel (PDRCH) by the IoT device; and
transmit the PDRCH to the first reader or a second reader,
wherein a proximity of the IoT device is identified based on the transmission of the PDRCH.

16. The IoT device of claim 15, wherein:
the PRDCH received by the IoT device corresponds to a message for inventorying the IoT device, and
the PDRCH is transmitted in response to the message for inventorying the IoT device.

17. The IoT device of claim 15, wherein the PDRCH includes information related to at least one of:
a device identifier,
a device type,
a device status,
a device energy level,
a backscatter loss,
an amplification gain,
a transmission power,
a measurement from the PRDCH, and
additional data requested in the PRDCH.

18. The IoT device of claim 15, wherein the proximity of the IoT device is based on:
transmission of the PDRCH by the IoT device including (i) successful reception of the PDRCH and (ii) information provided in the PDRCH, or
transmission of the PDRCH from the IoT device including (i) successful reception of the PDRCH, (ii) a measurement based on a signal received from the target device, and (iii) information provided in the PDRCH.

19. The IoT device of claim 15, wherein the parameters related to the PDRCH transmission include at least one of:
a transmission timing,
a resource in time, frequency, or code domain,
information related to transmission power control, and
a request for an additional data transmission in the PDRCH.

20. The IoT device of claim 15, wherein a proximity determination report includes at least one of:
one or more device identifiers of devices in proximity of the second reader,
a determined proximity range, and
a measurement associated with the PDRCH transmission by the IoT device in proximity of the second reader.
